(19) United States
(12) Patent Application Publication
(10) Pub. No.: US 2025/0184288 A1
(43) Pub. Date: Jun. 5, 2025

(54) INTERNAL GPU/NIC PARALLEL SWITCH FABRIC SYSTEM

(71) Applicant: Dell Products L.P., Round Rock, TX (US)

(72) Inventors: Claudio DeSanti, Santa Cruz, CA (US); Per Henrik Fremrot, Novato, CA (US); Joseph LaSalle White, San Jose, CA (US)

(21) Appl. No.: 18/596,757

(22) Filed: Mar. 6, 2024

Related U.S. Application Data
(60) Provisional application No. 63/605,347, filed on Dec. 1, 2023.

(51) Int. Cl. H04L 49/15

(52) U.S. Cl. CPC H04L 49/15

(57) ABSTRACT

An internal Graphics Processing Unit (GPU)/Network Interface Controller (NIC) parallel switch fabric system includes a computing device that is coupled to the plurality of external fabrics. The computing device includes a NIC set that provides access to each of the plurality of external fabrics, and a plurality of GPUs. The computing device also includes an internal switch fabric that is configured to couple each of the plurality of GPUs to the NIC set to provide each of the plurality of GPUs access to each of the plurality of external fabrics.

### CROSS-REFERENCE TO RELATED APPLICATION

This application claims the benefit of U.S. Provisional Patent Application Ser. No. 63/605,347, filed Dec. 1, 2023, which is incorporated by reference herein in its entirety.

### BACKGROUND

The present disclosure relates generally to information handling systems, and more particularly to providing an internal parallel switch fabric connecting Graphics Processing Units (GPUs) and Network Interface Controllers (NICs) in an information handling system.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems such as, for example, server devices, are sometimes used with Ethernet Artificial Intelligence (AI) fabrics, with each server device typically including a plurality of Graphics Processing Units (GPUs) connected to a plurality of Network Interface Controllers (NICs) via internal Peripheral Component Interconnect express (PCIe) switch devices, and with the server devices coupled together via external switch devices in order to interconnect their GPUs. However, the conventional configuration of such Ethernet AI fabrics presents scalability issues.

To provide a specific example, a POWEREDGE® XE9680 rack server available from DELL® Inc. of Round Rock, Texas, United States, may be provided with eight “THOR 2” NICs available from BROADCOM® Inc. of Palo Alto, California, United States, that are coupled to eight MI300X GPUs available from AMD® Inc. of Santa Clara, California, United States via four internal PCIe switch devices, with each internal PCIe switch device connected to two of the GPUS and two of the THOR 2 NICs. Each THOR 2 NIC supports 400 Gigabit Ethernet (GE) via a pair of Quad Small Form-factor Pluggable (QSFP) NIC ports that may each be connected to a switch port on a POWERSWITCH® Z9664 switch available from DELL® Inc. of Round Rock, Texas, United States that includes a TOMAHAWK 4 Application Specific Integrated Circuit (ASIC) that is available from BROADCOM® Inc. of Palo Alto, California, United States and that supports 64 switch ports at 400GE speeds, 128 switch ports at 200GE speeds, and 256 switch ports at 100GE speeds.

Conventional Ethernet AI fabrics like those described above utilize a respective 1-to-2 breakout cable to connect each of eight of the switch ports on the POWERSWITCH® Z9664 switch to a corresponding pair of QSFP NIC ports on the THOR 2 NICs in a POWEREDGE® XE9680 rack server, with eight 50 Gigabit per second (Gb/s) links in each switch port providing 400GE connectivity through its connected THOR 2 NIC to one of the GPUs via a 1-to-1 GPU/NIC mapping.

With such conventional Ethernet AI configurations, “pods” of GPUs may be defined to include 4 POWEREDGE® XE9680 rack servers connected to each POWERSWITCH® Z9664 switch via 32 switch ports, with the other 32 switch ports on the POWERSWITCH® Z9664 switch used to connected to spine switch devices. With GPU “pods” defined in such a manner using the specific hardware discussed above, conventional Ethernet AI configurations using that specific hardware can be scaled to up to 64 GPU “pods”, totaling (4 server devices/GPU “pod”*64 GPU “pods”=) 256 server devices, and (8 GPUs/server device*256 server devices=) 2048 GPUs. However, given the increasing demands on Ethernet AI fabrics, a maximum of 256 server devices and 2048 GPUs using the specific hardware discussed above presents a limit that may not satisfy future Ethernet AI fabric demands, and one of skill in the art in possession of the present disclosure will appreciate how other hardware with different features will suffer from similar issues when provided in the conventional Ethernet AI configurations described above.

Accordingly, it would be desirable to provide an Ethernet AI fabric configuration that addresses the issues discussed above.

### SUMMARY

According to one embodiment, an Information Handling System (IHS) includes a chassis; a Network Interface Controller (NIC) set that is included in the chassis and that provides access to each of a plurality of external fabrics; a plurality of Graphics Processing Units (GPUs) that are included in the chassis; and an internal switch fabric that is included in the chassis and configured to couple each of the plurality of GPUs to the NIC set to provide each of the plurality of GPUs access to each of the plurality of external fabrics.

### BRIEF DESCRIPTION OF THE DRAWINGS

FIG. 1 is a schematic view illustrating an embodiment of an Information Handling System (IHS).

FIG. 2 is a schematic view illustrating an embodiment of a computing device that may provide the internal GPU/NIC parallel switch fabric system of the present disclosure.

FIG. 3 is a schematic view illustrating an embodiment of a networking device that may be coupled to the computing device of FIG. 2 to provide an Ethernet AI fabric.

FIG. 4 is a flow chart illustrating an embodiment of a method for configuring an internal GPU/NIC parallel switch fabric for an Ethernet AI fabric.

FIG. 5 is a schematic view illustrating an embodiment of the computing device of FIG. 2 coupled to the networking device of FIG. 3 to provide a conventional Ethernet AI fabric configuration.

FIG. 6 is a schematic view illustrating an embodiment of NIC/GPU and networking device connectivity in the conventional Ethernet AI fabric configuration of FIG. 5.

FIG. 7 is a schematic view illustrating an embodiment of conventional NIC/GPU connectivity in the computing device of FIG. 2 used with the conventional Ethernet AI fabric configuration of FIG. 5.

FIG. 8 is a schematic view illustrating an embodiment of a conventional GPU pod provided using the computing devices of FIG. 2 and the networking device of FIG. 3 via the conventional Ethernet AI fabric configuration of FIG. 5.

FIG. 9A is a schematic view illustrating an embodiment of conventional networking device/GPU pod connectivity of the networking device of FIG. 3 and the GPU pods of FIG. 8 in the conventional Ethernet AI fabric configuration of FIG. 5.

FIG. 9B is a schematic view illustrating an embodiment of GPU communication in the Ethernet AI configuration of FIG. 9A.

FIGS. 10A and 10B are a schematic view illustrating an embodiment of the computing device of FIG. 2 coupled to the networking device of FIG. 3 and an additional networking device to provide an Ethernet AI fabric configuration according to the teachings of the present disclosure.

FIG. 11 is a schematic view illustrating an embodiment of NIC/GPU and networking device connectivity in the Ethernet AI fabric configuration of FIGS. 10A and 10B.

FIG. 12 is a schematic view illustrating an embodiment of NIC/GPU connectivity in the computing device of FIG. 2 in the Ethernet AI fabric configuration of FIGS. 10A and 10B.

FIG. 13 is a schematic view illustrating an embodiment of a GPU pod provided using the computing devices of FIG. 2, the networking device of FIG. 3, and the additional networking device of FIG. 10B via the Ethernet AI fabric configuration of FIGS. 10A and 10B.

FIG. 14A is a schematic view illustrating an embodiment of networking device/GPU pod connectivity of the networking device of FIG. 3, the additional networking device of FIG. 10B, and the GPU pods of FIG. 13 in the Ethernet AI fabric configuration of FIGS. 10A and 10B.

FIG. 14B is a schematic view illustrating an embodiment of GPU communication in the Ethernet AI configuration of FIG. 14A.

FIGS. 15A and 15B are a schematic view illustrating an embodiment of the computing device of FIG. 2 coupled to the networking device of FIG. 3 and an additional networking device to provide an Ethernet AI fabric configuration according to the teachings of the present disclosure.

FIG. 16 is a schematic view illustrating an embodiment of NIC/GPU and networking device connectivity in the Ethernet AI fabric configuration of FIGS. 15A and 15B.

FIG. 17 is a schematic view illustrating an embodiment of NIC/GPU connectivity in the computing device of FIG. 2 in the Ethernet AI fabric configuration of FIGS. 15A and 15B.

FIG. 18 is a schematic view illustrating an embodiment of a GPU pod provided using the computing devices of FIG. 2, the networking device of FIG. 3, and the additional networking device of FIG. 15B via the Ethernet AI fabric configuration of FIGS. 15A and 15B.

FIG. 19A is a schematic view illustrating an embodiment of networking device/GPU pod connectivity of the networking device of FIG. 3, the additional networking device of FIG. 15B, and the GPU pods of FIG. 18 in the Ethernet AI fabric configuration of FIGS. 15A and 15B.

FIG. 19B is a schematic view illustrating an embodiment of GPU communication in the Ethernet AI configuration of FIG. 19A.

FIGS. 20A, 20B, 20C, and 20D are a schematic view illustrating an embodiment of the computing device of FIG. 2 coupled to the networking device of FIG. 3 and additional networking devices to provide an Ethernet AI fabric configuration according to the teachings of the present disclosure.

FIG. 21 is a schematic view illustrating an embodiment of NIC/GPU and networking device connectivity in the Ethernet AI fabric configuration of FIGS. 20A, 20B, 20C, and 20D.

FIG. 22 is a schematic view illustrating an embodiment of NIC/GPU connectivity in the computing device of FIG. 2 in the Ethernet AI fabric configuration of FIGS. 20A, 20B, 20C, and 20D.

FIG. 23 is a schematic view illustrating an embodiment of a GPU pod provided using the computing devices of FIG. 2, the networking device of FIG. 3, and the additional networking devices of FIGS. 20B, 20C, and 20D via the Ethernet AI fabric configuration of FIGS. 20A, 20B, 20C, and 20D.

FIGS. 24A and 24B are a schematic view illustrating an embodiment of networking device/GPU pod connectivity of the networking device of FIG. 3, the additional networking devices of FIGS. 20B, 20C, and 20D, and the GPU pods of FIG. 23 in the Ethernet AI fabric configuration of FIGS. 20A, 20B, 20C, and 20D.

FIGS. 24C and 24D are a schematic view illustrating an embodiment of GPU communication in the Ethernet AI configuration of FIGS. 24A and 24B.

FIG. 25 is a schematic view illustrating another embodiment of NIC/GPU and networking device connectivity in the Ethernet AI fabric configuration of FIGS. 20A, 20B, 20C, and 20D.

FIG. 26 is a schematic view illustrating another embodiment of NIC/GPU connectivity in the computing device of FIG. 2 in the Ethernet AI fabric configuration of FIGS. 20A, 20B, 20C, and 20D.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

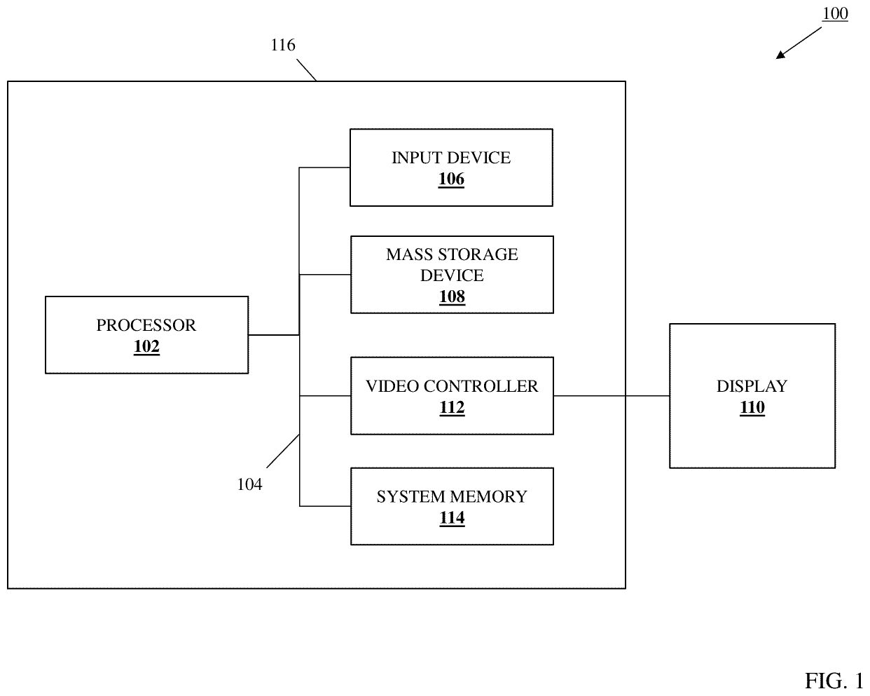

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

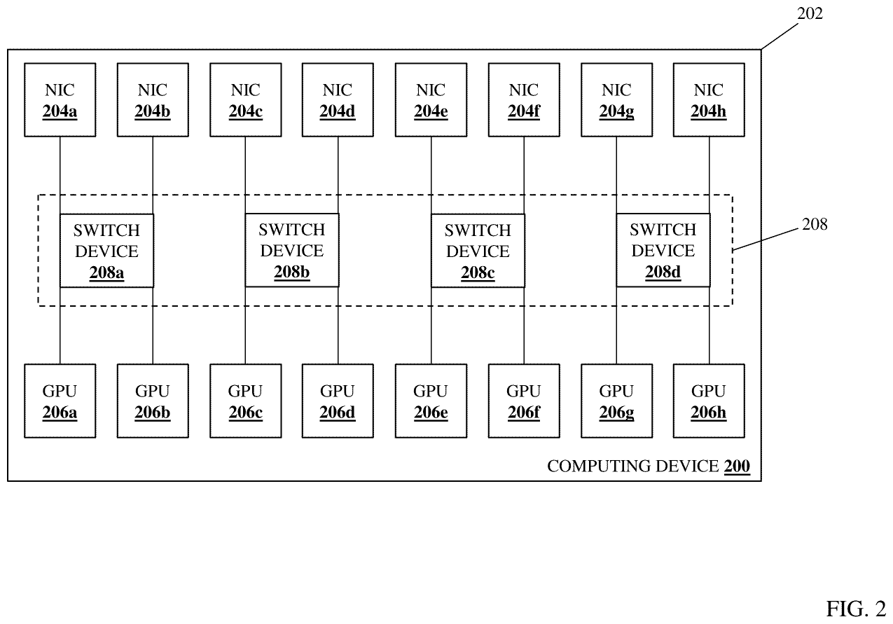

Referring now to FIG. 2, an embodiment of a computing device 200 is illustrated that may provide the internal GPU/NIC parallel switch fabric system of the present disclosure. In an embodiment, the computing device 200 may be provided by the IHS 100 discussed above with reference to FIG. 1, and/or may include some or all of the components of the IHS 100, and in specific examples may be provided by a server device such as, for example, the POWEREDGE® XE9680 rack server available from DELL® Inc. of Round Rock, Texas, United States. However, while illustrated and discussed as being provided by server devices, one of skill in the art in possession of the present disclosure will recognize that computing devices providing the internal GPU/NIC parallel switch fabric system of the present disclosure may include any computing devices that may be configured to operate similarly as the computing device 200 discussed below.

In the illustrated embodiment, the computing device 200 includes a chassis 202 that houses the components of the computing device 200, only some of which are illustrated and described below. For example, the chassis 202 may house an internal networking system including a plurality of networking devices that are provided by eight Network Interface Controllers (NICs) 204a, 204b, 204c, 204d, 204e, 204f, 204g, and 204h in the embodiments illustrated and described below. For example, each of the NICs 204a-204h may be provided by a respective THOR 2 NIC available from BROADCOM® Inc. of Palo Alto, California, United States, and as described above may each include a pair of Quad Small Form-factor Pluggable (QSFP) NIC ports that are configured to support up to 400 Gigabit Ethernet (GE) data transmission speeds. However, while a particular number of a particular type of NIC having particular NIC features is described below, one of skill in the art in possession of the present disclosure will appreciate how the teaching of the present disclosure may be applied to different numbers of NICs, different types of NICs, and/or NICs having different NIC features while remaining within the scope of the present disclosure as well. For example, while described as “NICs”, one of skill in the art in possession of the present disclosure will appreciate how the NICs 204a-204h in the internal networking system may be provided by networking components included in SmartNICs, Data Processing Units (DPUs), and/or other networking systems that would be apparent to one of skill in the art in possession of the present disclosure.

The chassis 202 may also house a processing system including a plurality of processing devices that are provided by eight Graphics Processing Units (GPUs) 206a, 206b, 206c, 206d, 206e, 206f, 206g, and 206h in the embodiments illustrated and described below. For example, each of the GPUs 206a-206h may be provided by a respective MI300X GPU available from AMD® Inc. of Santa Clara, California, United States. However, while a particular number of a particular type of GPU is described below, one of skill in the art in possession of the present disclosure will appreciate how the teaching of the present disclosure may be applied to different numbers of processing devices and/or different types of processing devices while remaining within the scope of the present disclosure as well.

The chassis 202 may also house an internal switch fabric 208 coupling its networking system to its processing system. In the illustrated embodiment, the internal switch fabric 208 includes four internal switch devices 208a, 208b, 208c, and 208d that each couple a pair of the NICs in the networking system to a pair of the GPUs in the processing system, with the switch device 208a coupling the NICS 204a and 204b to the GPUs 206a and 206b, the switch device 208b coupling the NICS 204c and 204d to the GPUs 206c and 206d, the switch device 208c coupling the NICS 204e and 204f to the GPUs 206e and 206f, and the switch device 208d coupling the NICS 204g and 204h to the GPUs 206g and 206h in the examples illustrated and described below. For example, each of the switch devices 208a, 208b, 208c, and 208d may be provided by a respective Peripheral Component Interconnect express (PCIe) switch, a Compute eXpress Link (CXL) switch, and/or other internal switch devices that would be apparent to one of skill in the art in possession of the present disclosure. However, while a particular number of particular types of internal switch devices in a particular internal switch device configuration is illustrated and described below, one of skill in the art in possession of the present disclosure will appreciate how the teaching of the present disclosure may be applied to different numbers of switch devices, different types of switch devices, and/or switch devices in a different switch device configuration while remaining within the scope of the present disclosure as well.

Furthermore, while a specific computing device 200 has been illustrated and described, one of skill in the art in possession of the present disclosure will recognize that computing devices (or other devices operating according to the teachings of the present disclosure in a manner similar to that described below for the computing device 200) may include a variety of components and/or component configurations for providing conventional computing device functionality, as well as the internal GPU/NIC parallel switch fabric functionality discussed below, while remaining within the scope of the present disclosure as well.

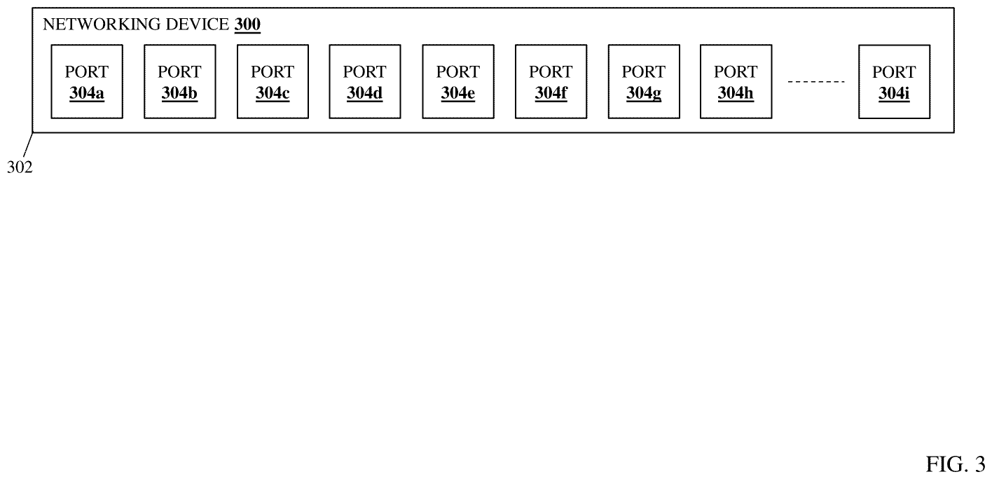

Referring now to FIG. 3, an embodiment of a networking device 300 is illustrated that may be coupled to the computing device 200 of FIG. 2 to provide the Ethernet Artificial Intelligence (AI) fabric of the present disclosure. In an embodiment, the networking device 300 may be provided by the IHS 100 discussed above with reference to FIG. 1, and/or may include some or all of the components of the IHS 100, and in specific examples may be provided by an external switch device such as, for example, a POWERSWITCH® Z9664 switch available from DELL® Inc. of Round Rock, Texas, United States. However, while illustrated and discussed as being provided by switch devices, one of skill in the art in possession of the present disclosure will recognize that networking devices provided in the Ethernet AI fabric system of the present disclosure may include any networking devices that may be configured to operate similarly as the networking device 300 discussed below.

In the illustrated embodiment, the networking device 300 includes a chassis 302 that houses the components of the networking device 300, only some of which are illustrated and described below. For example, the chassis 302 may house a port system that includes a plurality of switch ports 304a, 304b, 304c, 304d, 304e, 304f, 304g, 304h, and up to 304i in the examples illustrated and described below. In a specific example, the chassis 302 may house a networking processing system (not illustrated) provided by a TOMAHAWK 4 Application Specific Integrated Circuit (ASIC) that is available from BROADCOM® Inc. of Palo Alto, California, United States, and that supports 64 switch ports at 400GE speeds, 128 switch ports at 200GE speeds, and 256 switch ports at 100GE speeds. However, while a particular number of particular types of ports having particular port features is described below, one of skill in the art in possession of the present disclosure will appreciate how the teaching of the present disclosure may be applied to networking devices having different numbers of ports, different types of ports, and/or ports having different port features while remaining within the scope of the present disclosure as well.

Furthermore, while a specific networking device 300 has been illustrated and described, one of skill in the art in possession of the present disclosure will recognize that networking devices (or other devices operating according to the teachings of the present disclosure in a manner similar to that described below for the networking device 300) may include a variety of components and/or component configurations for providing conventional networking device functionality, as well as the internal Ethernet AI fabric functionality discussed below, while remaining within the scope of the present disclosure as well. Further still, other networking devices 600, 900, 1000, 1100, 1102, 1400a, 1400b, 1500, 1600, 1602, 1900a, 1900b, 2000, 2006, 2012, 2100, 2101, 2102, 2103, 2400a, 2400b, 2500, 2501, 2502, and 2503 are described in some of the specific examples provided below, and one of skill in the art in possession of the present disclosure will appreciate how any of those networking devices may be substantially similar to the networking device 300 discussed in detail above.

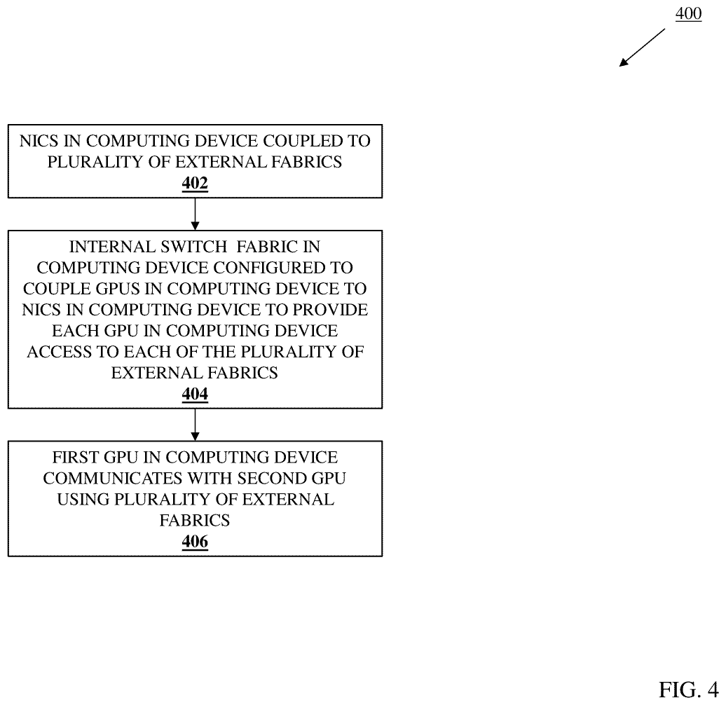

Referring now to FIG. 4, an embodiment of a method 400 for configuring an internal Graphics Processing Unit (GPU)/Network Interface Controller (NIC) parallel switch fabric for an Ethernet Artificial Intelligence (AI) fabric is illustrated. As discussed below, the systems and methods of the present disclosure provide internal parallelism for GPUs in a computing device via an internal switch fabric in that computing device that connects each of those GPUs to parallel external fabrics that are accessible via a plurality of NICs in that computing device. For example, the internal GPU/NIC parallel switch fabric system of the present disclosure may include a computing device that is coupled to the plurality of external fabrics. The computing device includes at least one NIC that provides access to each of the plurality of external fabrics, and a plurality of GPUs. The computing device also includes an internal switch fabric that is configured to couple each of the plurality of GPUs to the at least one NIC to provide each of the plurality of GPUs access to each of the plurality of external fabrics. As such, Ethernet AI fabrics may be scaled to include greater numbers of GPUs than is available via conventional Ethernet AI fabric configurations.

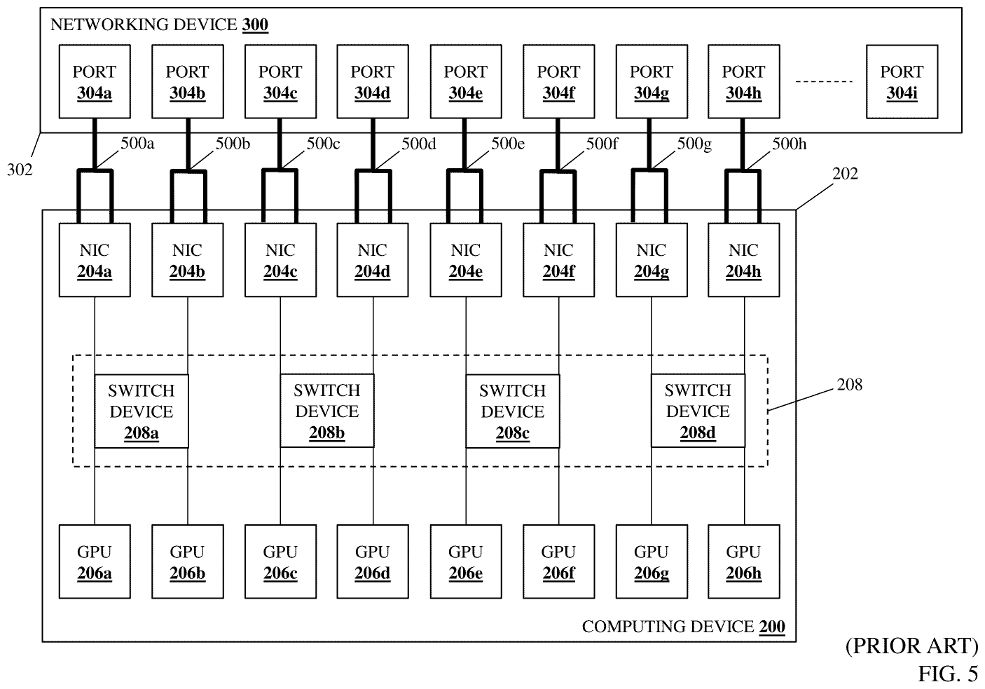

With reference to FIGS. 5, 6, 7, 8, 9A, and 9B, an embodiment of a conventional Ethernet AI fabric configuration is illustrated and briefly described for purposes of comparison to the Ethernet AI fabric configurations provided according to the teachings of the present disclosure. With reference to FIG. 5, the computing device 200 may be coupled to the networking device 300 to provide the conventional Ethernet AI fabric configuration by connecting a breakout cable 500a to the port 304a on the networking device 300 and to the two ports (e.g., the pair of QSFP ports discussed above) on the NIC 204a, connecting a breakout cable 500b to the port 304b on the networking device 300 and to the two ports (e.g., the pair of QSFP ports discussed above) on the NIC 204b, connecting a breakout cable 500c to the port 304c on the networking device 300 and to the two ports (e.g., the pair of QSFP ports discussed above) on the NIC 204c, connecting a breakout cable 500d to the port 304d on the networking device 300 and to the two ports (e.g., the pair of QSFP ports discussed above) on the NIC 204d, connecting a breakout cable 500e to the port 304e on the networking device 300 and to the two ports (e.g., the pair of QSFP ports discussed above) on the NIC 204e, connecting a breakout cable 500f to the port 304f on the networking device 300 and to the two ports (e.g., the pair of QSFP ports discussed above) on the NIC 204f, connecting a breakout cable 500g to the port 304g on the networking device 300 and to the two ports (e.g., the pair of QSFP ports discussed above) on the NIC 204g, and connecting a breakout cable 500h to the port 304h on the networking device 300 and to the two ports (e.g., the pair of QSFP ports discussed above) on the NIC 204h.

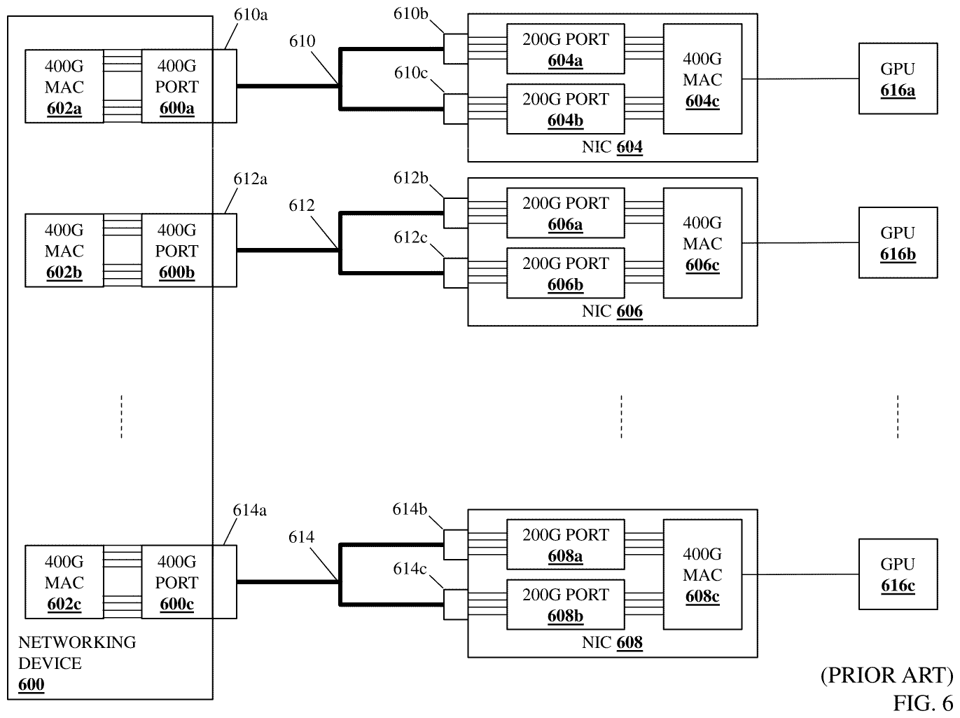

With reference to FIG. 6, a specific example of the networking device/NIC/GPU connections in the conventional Ethernet AI fabric configuration of FIG. 5 is illustrated. In the illustrated embodiment, a networking device 600 may provide the networking device 300 of FIG. 5, and may include a plurality of 400G ports 600a, 600b, and up to 600c that may provide the ports 304a-304i on the networking device 300 of FIG. 5. As will be appreciated by one of skill in the art in possession of the present disclosure, the networking device 600 may include a 400G Media Access Controller (MAC) 602a providing eight 50G lanes to the 400G port 600a (as illustrated by the eight lines between the 400G MAC 602a and the 400G port 600a in FIG. 6), a 400G MAC 602b providing eight 50G lanes to the 400G port 600b (as illustrated by the eight lines between the 400G MAC 602b and the 400G port 600b in FIG. 6), and up to a 400G MAC 602c providing eight 50G lanes to the 400G port 600c (as illustrated by the eight lines between the 400G MAC 602c and the 400G port 600c in FIG. 6).

A computing device (not illustrated) that may provide the computing device 200 of FIG. 5 includes NICs 604, 606, and up to 608 that may provide the NICs 204a-204h of FIG. 5. In the illustrated embodiment, the NIC 604 includes a pair of 200G ports 604a and 604b coupled to a 400G MAC 604c, the NIC 606 includes a pair of 200G ports 606a and 606b coupled to a 400G MAC 606c, and the NIC 608 includes a pair of 200G ports 608a and 608b coupled to a 400G MAC 608c. A plurality of breakout cables 610, 612, and up to 614 couple the 400G ports 600a, 600b, and up to 600c, respectively, to the NICs 604, 606, and up to 608, respectively, and may provide the breakout cables 500a-500h of FIG. 5.

As can be seen, the breakout cable 610 includes a first connector 610a connected to the 400G port 600a, and a pair of second connectors 610b and 610c connected to the 200G ports 604a and 604b, respectively, to couple four of the eight 50G lanes (provided by the 400G MAC 602a to the 400G port 600a) from the 400G port 600a to the 200G port 604a (as illustrated by the four lines between the second connector 610b and the 200G port 604a in FIG. 6), and to couple the other four of the eight 50G lanes (provided by the 400G MAC 602a to the 400G port 600a) from the 400G port 600a to the 200G port 604b (as illustrated by the four lines between the second connector 610c and the 200G port 604b in FIG. 6), with four 50G lanes provided between the 200G port 604a and the 400G MAC 604c (as illustrated by the four lines between the 200G port 604a and the 400G MAC 604c in FIG. 6), and four 50G lanes provided between the 200G port 604b and the 400G MAC 604c (as illustrated by the four lines between the 200G port 604b and the 400G MAC 604c in FIG. 6). The internal switch fabric (not illustrated, but which may provide the internal switch fabric 208 of FIG. 5) is configured with a 1-to-1 GPU-to-NIC mapping between a GPU 616a that may provide the GPU 206a of FIG. 5, and the 400G MAC 604c in the NIC 604, which one of skill in the art in possession of the present disclosure will recognize provides 400G connectivity to that GPU 616a.

Similarly, the breakout cable 612 includes a first connector 612a connected to the 400G port 600b, and a pair of second connectors 612b and 612c connected to the 200G ports 606a and 606b, respectively, to couple four of the eight 50G lanes (provided by the 400G MAC 602b to the 400G port 600b) from the 400G port 600b to the 200G port 606a (as illustrated by the four lines between the second connector 612b and the 200G port 606a in FIG. 6), and to couple the other four of the eight 50G lanes (provided by the 400G MAC 602b to the 400G port 600b) from the 400G port 600b to the 200G port 606b (as illustrated by the four lines between the second connector 612c and the 200G port 606b in FIG. 6), with four 50G lanes provided between the 200G port 606a and the 400G MAC 606c (as illustrated by the four lines between the 200G port 606a and the 400G MAC 606c in FIG. 6), and four 50G lanes provided between the 200G port 606b and the 400G MAC 606c (as illustrated by the four lines between the 200G port 606b and the 400G MAC 606c in FIG. 6). The internal switch fabric (not illustrated, but which may provide the internal switch fabric 208 of FIG. 5) is configured with a 1-to-1 GPU-to-NIC mapping between a GPU 616b that may provide the GPU 206b of FIG. 5, and the 400G MAC 606c in the NIC 606, which one of skill in the art in possession of the present disclosure will recognize provides 400G connectivity to that GPU 616b.

Similarly as well, the breakout cable 614 includes a first connector 614a connected to the 400G port 600c, and a pair of second connectors 614b and 614c connected to the 200G ports 608a and 608b, respectively, to couple four of the eight 50G lanes (provided by the 400G MAC 602c to the 400G port 600c) from the 400G port 600c to the 200G port 608a (as illustrated by the four lines between the second connector 614b and the 200G port 608a in FIG. 6), and to couple the other four of the eight 50G lanes (provided by the 400G MAC 602c to the 400G port 600c) from the 400G port 600c to the 200G port 608b (as illustrated by the four lines between the second connector 614c and the 200G port 608b in FIG. 6), with four 50G lanes provided between the 200G port 608a and the 400G MAC 608c (as illustrated by the four lines between the 200G port 608a and the 400G MAC 608c in FIG. 6), and four 50G lanes provided between the 200G port 608b and the 400G MAC 608c (as illustrated by the four lines between the 200G port 608b and the 400G MAC 608c in FIG. 6). The internal switch fabric (not illustrated, but which may provide the internal switch fabric 208 of FIG. 5) is configured with a 1-to-1 GPU-to-NIC mapping between a GPU 616c that may provide the GPU 206h of FIG. 5, and the 400G MAC 608c in the NIC 608, which one of skill in the art in possession of the present disclosure will recognize provides 400G connectivity to that GPU 616c.

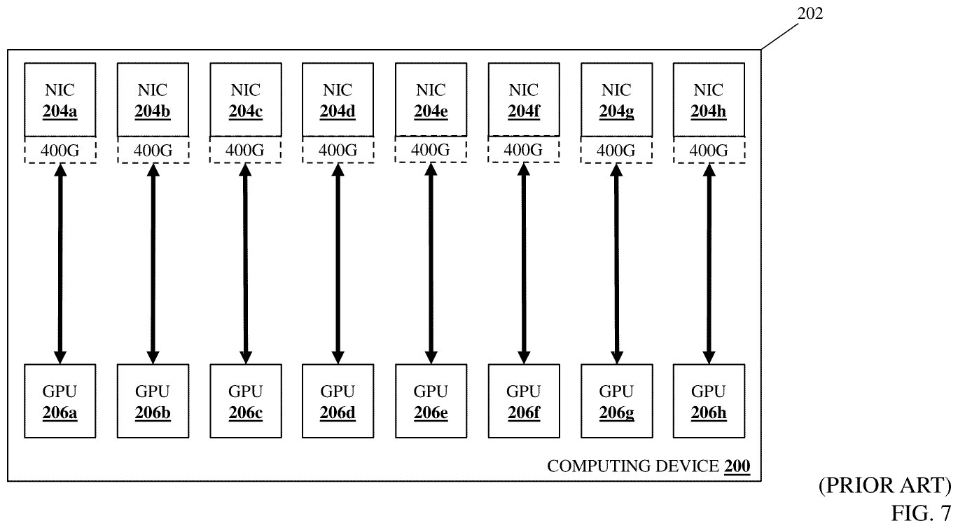

With reference to FIG. 7, the 1-to-1 GPU-to-NIC mappings provided by the internal switch fabric 208 (not illustrated in FIG. 7 for clarity) between the GPUs 206a-206h and the NICs 204a-204h, respectively, in the conventional Ethernet AI fabric configuration of FIG. 5 is illustrated, with a 1-to-1 GPU-to-NIC mapping provided by the switch device 208a enabling 400G connectivity between the GPU 206a and the NIC 204a, a 1-to-1 GPU-to-NIC mapping provided by the switch device 208a enabling 400G connectivity between the GPU 206b and the NIC 204b, a 1-to-1 GPU-to-NIC mapping provided by the switch device 208b enabling 400G connectivity between the GPU 206c and the NIC 204c, a 1-to-1 GPU-to-NIC mapping provided by the switch device 208b enabling 400G connectivity between the GPU 206d and the NIC 204d, a 1-to-1 GPU-to-NIC mapping provided by the switch device 208c enabling 400G connectivity between the GPU 206e and the NIC 204e, a 1-to-1 GPU-to-NIC mapping provided by the switch device 208c enabling 400G connectivity between the GPU 206f and the NIC 204f, a 1-to-1 GPU-to-NIC mapping provided by the switch device 208d enabling 400G connectivity between the GPU 206g and the NIC 204g, and a 1-to-1 GPU-to-NIC mapping provided by the switch device 208d enabling 400G connectivity between the GPU 206h and the NIC 204h.

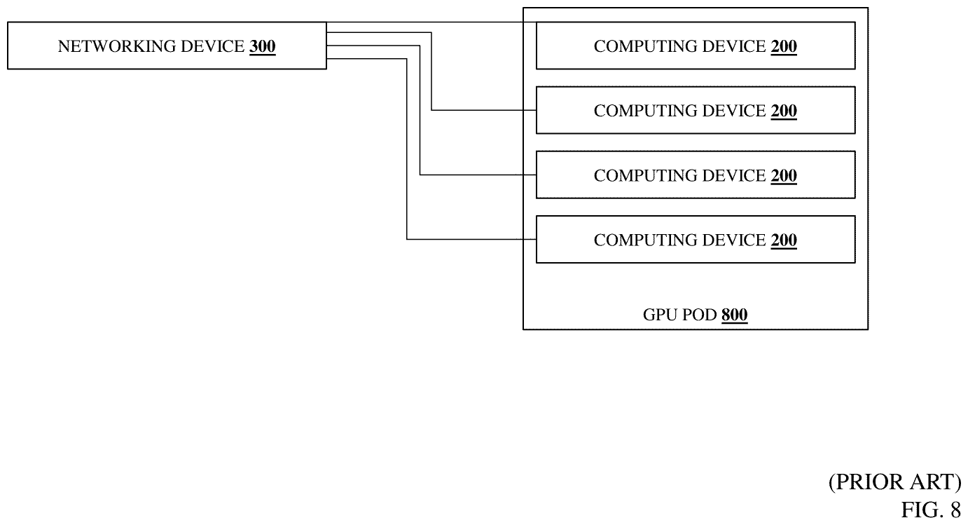

With reference to FIG. 8, a GPU “pod” 800 may be defined in the conventional Ethernet AI fabric configuration described above and may be provided by connecting four of the computing devices 200 discussed above to one of the networking devices 300 discussed above. For example, the networking device 300 of FIG. 8 may include 64 ports, with 8 of the 64 ports on the networking device 300 coupled to a first of the computing devices 200 in the GPU pod 800 (e.g., the “top” computing device 200 in FIG. 8) similarly as described above with reference to FIG. 5, 8 of the 64 ports on the networking device 300 coupled to a second of the computing devices 200 in the GPU pod 800 (e.g., the “second from the top” computing device 200 in FIG. 8) similarly as described above with reference to FIG. 5, 8 of the 64 ports on the networking device 300 coupled to a third of the computing devices 200 in the GPU pod 800 (e.g., the “third from the top” computing device 200 in FIG. 8) similarly as described above with reference to FIGS. 5, and 8 of the 64 ports on the networking device 300 coupled to a fourth of the computing devices 200 in the GPU pod 800 (e.g., the “bottom” computing device 200 in FIG. 8) similarly as described above with reference to FIG. 5.

As such, in this specific example, 32 ports on the networking device 300 may be coupled to the computing devices 200 in the GPU pod 800, with the remaining 32 ports coupled to spine switch devices as described in further detail below. Furthermore, while a 64-port networking device 300 providing 400G/port is described, one of skill in the art in possession of the present disclosure will appreciate how the teachings of the present disclosure may be applied to networking devices with 32 or fewer ports, as well as networking devices with 128, 256, 512 or more ports, and/or ports with different speeds, while remaining within the scope of the present disclosure as well.

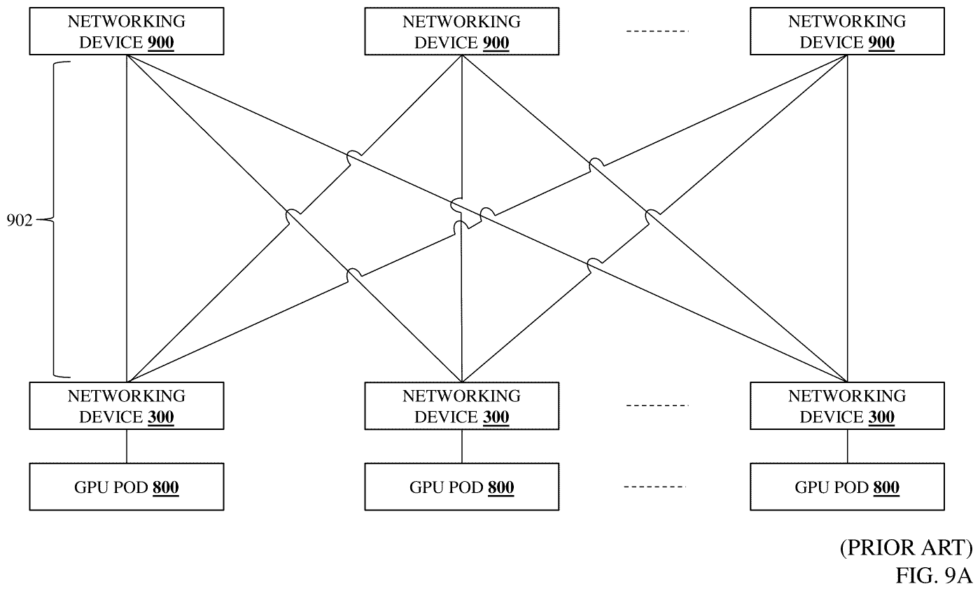

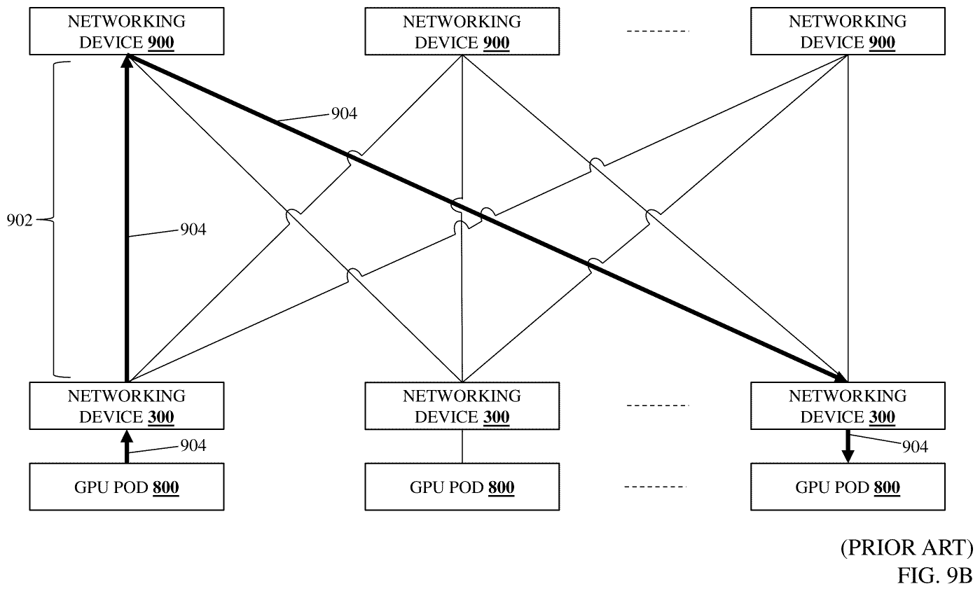

With reference to FIG. 9A, the conventional Ethernet AI fabric configuration described above may include 32 networking devices 900 (configured as the “spine switch devices” discussed above) that each include 64 ports, and thus may each couple to 64 of the networking devices 300 that are each coupled to a respective one of the GPU pods 800 discussed above to provide a single fabric 902. As illustrated in FIG. 9B, any GPU in any of the GPU pods 800 may perform GPU communication operations 904 to communicate with other GPUs (in other GPU pods 800 in the specific example illustrated in FIG. 9B, or in its same GPU pod) via the single fabric 902. Using the definition of the GPU pod 800 for the specific hardware discussed above, the conventional Ethernet AI fabric of FIG. 9A allows for the coupling of up to (4 computing devices/GPU pod*64 GPU pods=) 256 computing devices, and up to (8 GPUs/computing device*256 computing devices=) 2048 GPUs. As discussed above, given the increasing demands on Ethernet AI fabrics, a maximum 256 server devices and 2048 GPUs for the specific hardware discussed above (or similar maximums for different hardware) presents a limit that may not satisfy future Ethernet AI fabric demands. As such, the internal GPU/NIC parallel switch fabric system of the present disclosure provides internal parallelism for GPUs in a computing device via an internal switch fabric in that computing device that connects each of those GPUs to parallel external fabrics that are accessible via a plurality of NICs in that computing device in order to increase the number of computing devices/GPUs that may be coupled together using any particular hardware relative to when that hardware is provided in the conventional Ethernet AI fabric configurations described above.

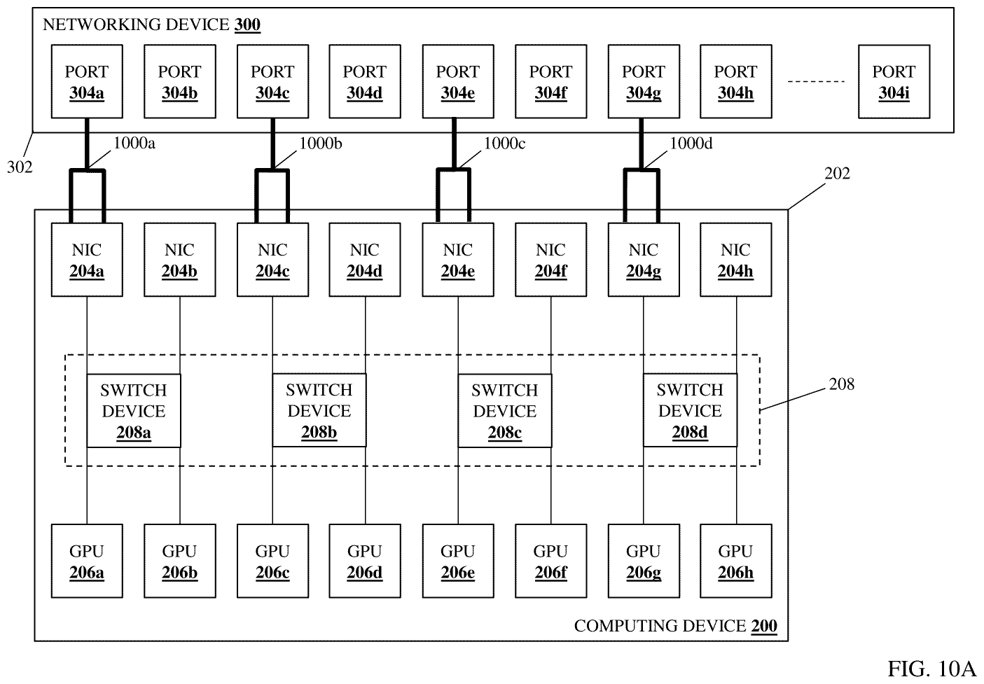

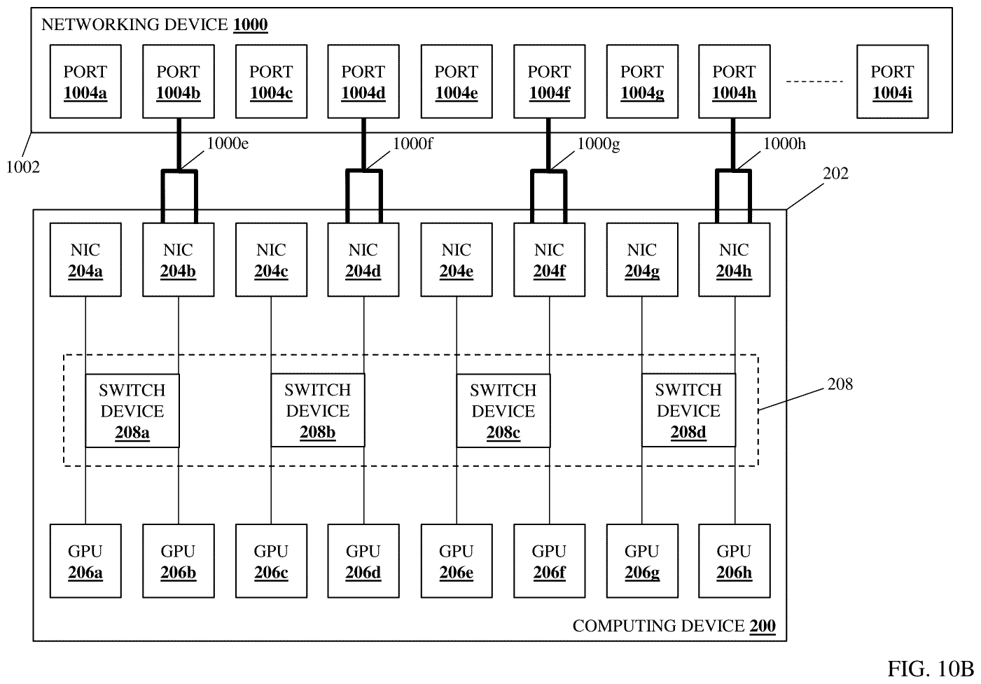

The method 400 will now be described with reference to some specific examples of implementations of the teachings of the present disclosure. The first example described with reference to FIGS. 10A, 10B, 11, 12, 13, 14A, and 14B provides an example of “odd/even” internal switch fabric scaling that provides GPUs in the computing device 200 access to an “odd” fabric via “odd” NICs provided by the “first” NIC 204a, the “third” NIC 204c, the “fifth” NIC 204e, and the “seventh” NIC 204g in the computing device 200, while providing those GPUs access to an “even” fabric via “even” NICs provided by the “second” NIC 204b, the “fourth” NIC 204d, the “sixth” NIC 204f, and the “eighth” NIC 204h in the computing device 200.

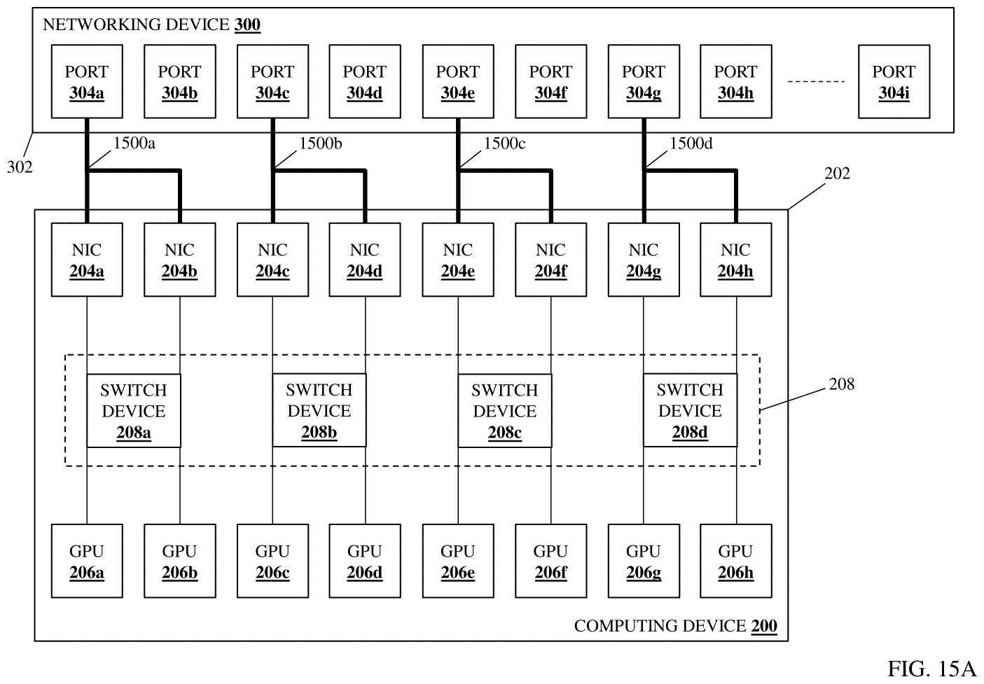

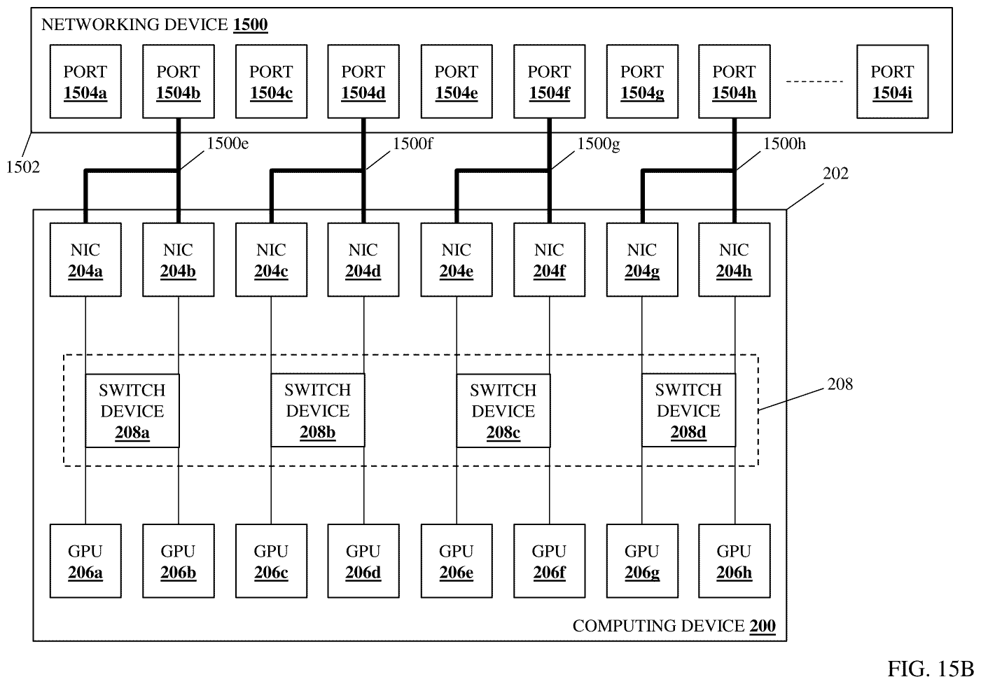

The second example described with reference to FIGS. 15A, 15B, 16, 17, 18, 19A, and 19B provides an example of “top/bottom” internal switch fabric scaling that provides GPUs in the computing device 200 access to a “top” fabric via “top” ports (i.e., a first of the pair of ports) on the NICs 204a-204h in the computing device 200, while providing those GPUs access to a “bottom” fabric via “bottom” ports (a second of the pair of ports) on the NICs 204a-204h in the computing device 200.

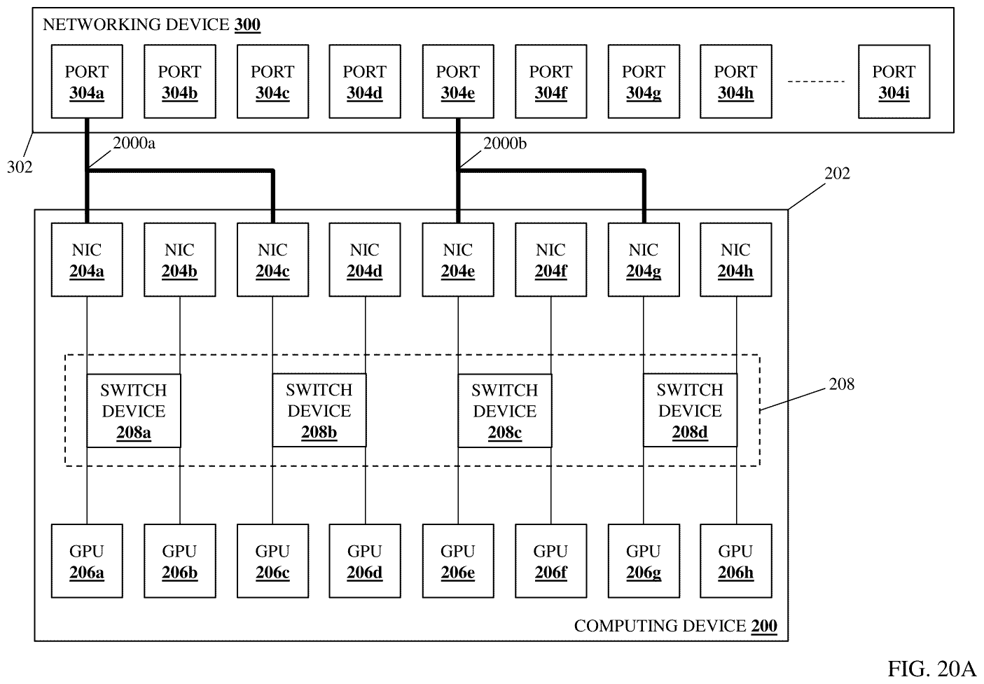

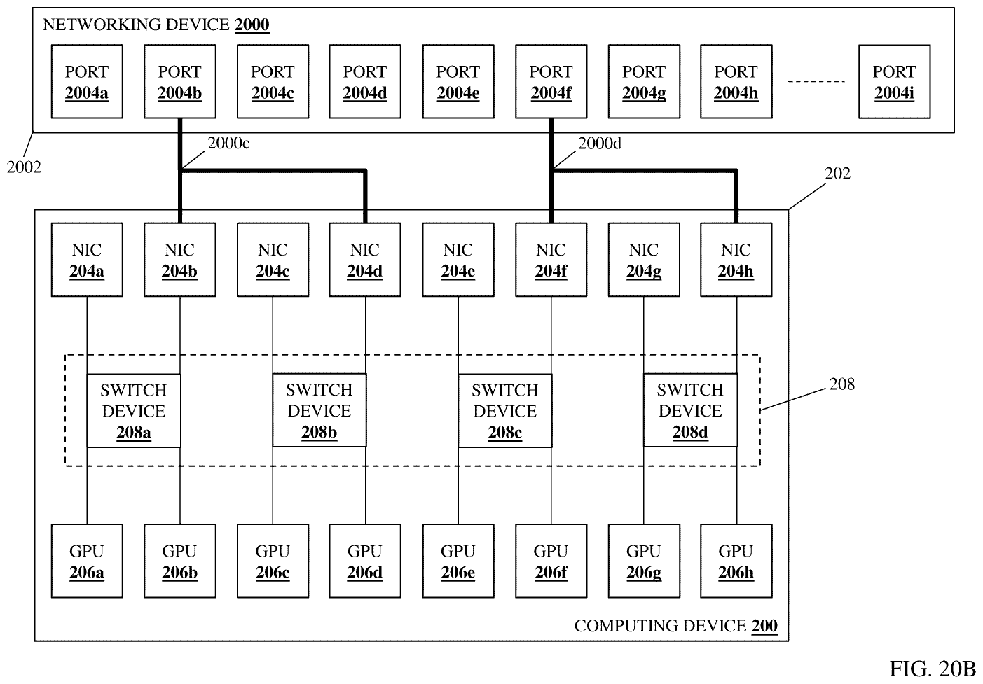

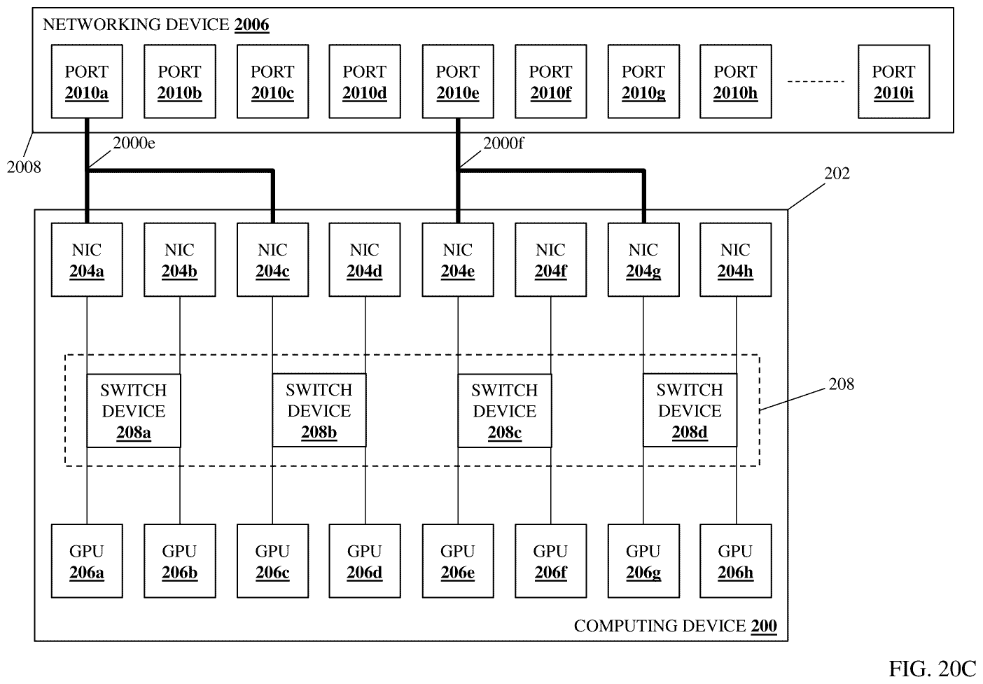

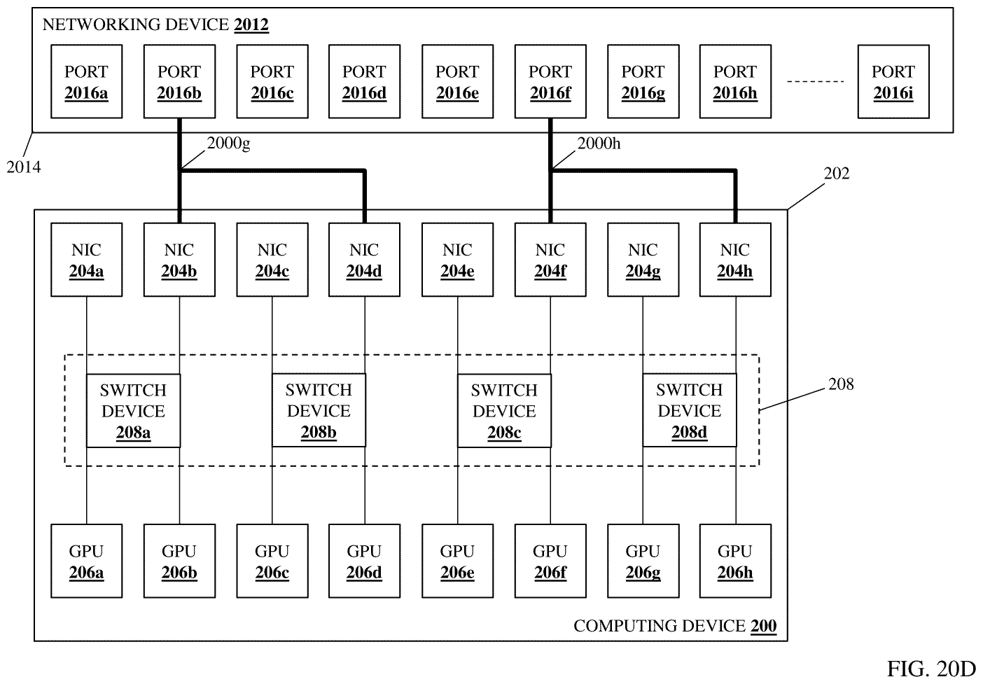

The third example described with reference to FIGS. 20A, 20B, 20C, 20D, 21, 22, 23, 24A, 24B, 24C, and 24D provides an example of “top/odd”, “top/even”, “bottom/odd”, “bottom/even” internal switch fabric scaling that provides GPUs in the computing device 200 access to a “top/odd” fabric via “top” ports (i.e., a first of the pair of ports) on “odd” NICs provided by the “first” NIC 204a, the “third” NIC 204c, the “fifth” NIC 204e, and the “seventh” NIC 204g in the computing device 200; providing those GPUs access to a “top/even” fabric via “top” ports (i.e., a first of the pair of ports) on “even” NICs provided by the “second” NIC 204b, the “fourth” NIC 204d, the “sixth” NIC 204f, and the “eighth” NIC 204h in the computing device 200; providing those GPUs access to a “bottom/odd” fabric via “bottom” ports (i.e., a second of the pair of ports) on the “odd” NICs provided by the “first” NIC 204a, the “third” NIC 204c, the “fifth” NIC 204e, and the “seventh” NIC 204g in the computing device 200; and providing those GPUs access to a “bottom/even” fabric via “bottom” ports (i.e., a second of the pair of ports) on the “even” NICs provided by the “second” NIC 204b, the “fourth” NIC 204d, the “sixth” NIC 204f, and the “eighth” NIC 204h in the computing device 200.

As such, each of the GPUs in the computing device 200 in the different examples referenced above and described below may be provided access to each of the available external fabrics via a “NIC set” that one of skill in the art in possession of the present disclosure will appreciate is provided by two NICs in the “odd/even” internal switch fabric scaling referenced above and described below, is provided by a single NIC in the “top/bottom” internal switch fabric scaling referenced above and described below, and is provided by two NICs in the “top/odd”, “top/even”, “bottom/odd”, “bottom/even” internal switch fabric scaling referenced above and described below. However, while a few specific examples of the internal switch fabric scaling that utilize intuitive naming conventions based on the physical features of the NICs 204a-204h in the computing device 200 are provided herein, one of skill in the art in possession of the present disclosure will appreciate how the teachings described herein may provide a variety of other internal switch fabric scaling configurations while remaining within the scope of the present disclosure as well.

The method 400 begins at block 402 where a plurality of NICs in a computing device are coupled to a plurality of external fabrics. With reference to FIGS. 10A and 10B and a first implementation of the teachings of the present disclosure, in an embodiment of block 402, the computing device 200 may be coupled to the networking device 300 and a networking device 1000 (which is substantially similar to the networking device 300 as described above and includes a chassis 1002 and ports 1004a-1004i similar to the chassis 302 and the ports 304a-304i) to provide an Ethernet AI fabric configuration according to the teachings of the present disclosure that utilizes the “odd/even” internal switch fabric scaling described above. As illustrated in FIG. 10A, a breakout cable 1000a may connect the port 304a on the networking device 300 to the two ports (e.g., the pair of QSFP ports discussed above) on the NIC 204a, a breakout cable 1000b may connect the port 304c on the networking device 300 to the two ports (e.g., the pair of QSFP ports discussed above) on the NIC 204c, a breakout cable 1000c may connect the port 304e on the networking device 300 to the two ports (e.g., the pair of QSFP ports discussed above) on the NIC 204e, and a breakout cable 1000d may connect the port 304g on the networking device 300 to the two ports (e.g., the pair of QSFP ports discussed above) on the NIC 204g. Continuing with the intuitive naming conventions described above, the networking device 300 may be configured to provide access to an “odd” fabric, and may have four of its ports 304a, 304c, 304e, and 304g connected via respective breakout cables 1000a, 1000b, 1000c, and 1000d to the pairs of ports on each of the “odd” NICs on the computing device 200 (i.e., the “first” NIC 204a, the “third” NIC 204c, the “fifth” NIC 204e, and the “seventh” NIC 204g, respectively).

As illustrated in FIG. 10B, a breakout cable 1000e may connect the port 1004b on the networking device 1000 to the two ports (e.g., the pair of QSFP ports discussed above) on the NIC 204b, a breakout cable 1000f may connect the port 1004d on the networking device 1000 to the two ports (e.g., the pair of QSFP ports discussed above) on the NIC 204d, a breakout cable 1000g may connect the port 1004f on the networking device 1000 to the two ports (e.g., the pair of QSFP ports discussed above) on the NIC 204f, and a breakout cable 1000h may connect the port 1004h on the networking device 1000 to the two ports (e.g., the pair of QSFP ports discussed above) on the NIC 204h. Continuing with the intuitive naming conventions described above, the networking device 1000 may be configured to provide access to an “even” fabric, and may have four of its ports 1004b, 1004d, 1004f, and 1004h connected via respective breakout cables 1000e, 1000f, 1000g, and 1000h to the pairs of ports on each of the “even” NICs on the computing device 200 (i.e., the “second” NIC 204b, the “fourth” NIC 204d, the “sixth” NIC 204f, and the “eighth” NIC 204h, respectively).

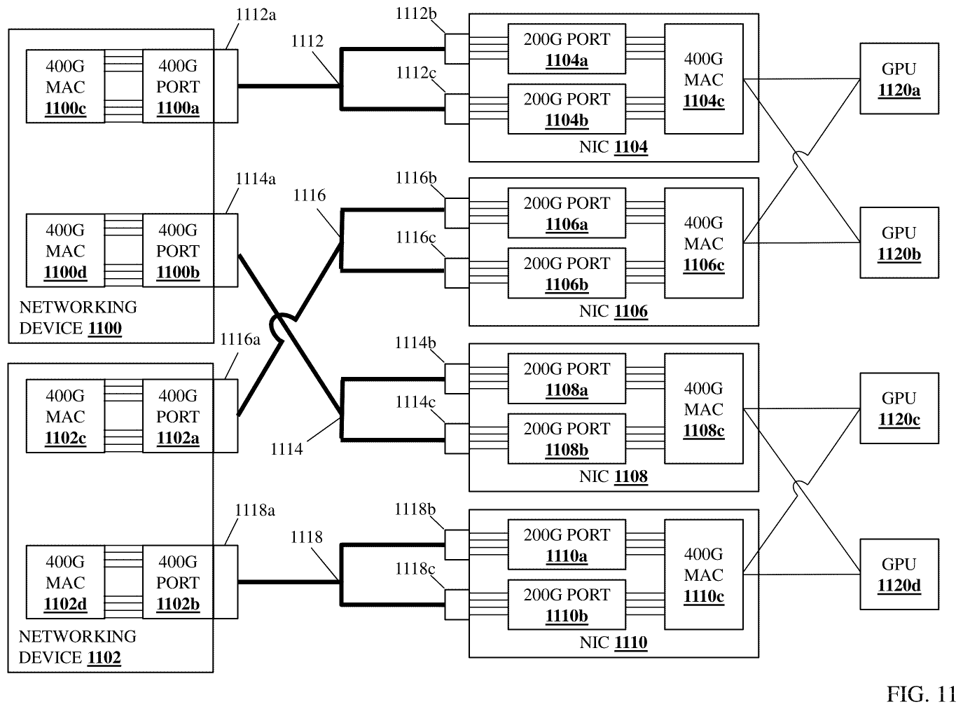

With reference to FIG. 11, a specific example of the networking device/NIC/GPU connections in the Ethernet AI fabric configuration of FIGS. 10A and 10B is illustrated. In the illustrated embodiment, a networking device 1100 is illustrated connected to two NICs in a computing device, a networking device 1102 is illustrated connected to two NICs in that computing device, and one of skill in the art in possession of the present disclosure will appreciate how FIG. 11 may illustrate the connection of the networking device 300 (provided by the networking device 1100) to the NICs 204a and 204c on the computing device 200 illustrated in FIG. 10A, and the connection of the networking device 1000 (provided by the networking device 1102) to the NICs 204b and 204d on the computing device 200 illustrated in FIG. 10B. Furthermore, one of skill in the art in possession of the present disclosure will also appreciate how FIG. 11 may also illustrate the connection of the networking device 300 (provided by the networking device 1100) to the NICs 204e and 204g on the computing device 200 illustrated in FIG. 10A, and the connection of the networking device 1000 (provided by the networking device 1102) to the NICs 204f and 204h on the computing device 200 illustrated in FIG. 10B.

As illustrated, the networking device 1100 may include a pair of 400G ports 1100a and 1100b that may provide the ports 304a and 304c (or the ports 304e and 304g) on the networking device 300 of FIG. 10A, and the networking device 1102 may include a pair of 400G ports 1102a and 1102b that may provide the ports 1004b and 1004d (or the ports 1004f and 1004h) on the networking device 1000 of FIG. 10B. As will be appreciated by one of skill in the art in possession of the present disclosure, the networking device 1100 may include a 400G MAC 1100c providing eight 50G lanes to the 400G port 1100a (as illustrated by the eight lines between the 400G MAC 1100c and the 400G port 1100a in FIG. 11), and a 400G MAC 1100d providing eight 50G lanes to the 400G port 1100b (as illustrated by the eight lines between the 400G MAC 1100d and the 400G port 1100b in FIG. 11). Similarly, the networking device 1102 may include a 400G MAC 1102c providing eight 50G lanes to the 400G port 1102a (as illustrated by the eight lines between the 400G MAC 1102c and the 400G port 1102a in FIG. 11), and a 400G MAC 1102d providing eight 50G lanes to the 400G port 1102b (as illustrated by the eight lines between the 400G MAC 1102d and the 400G port 1102b in FIG. 11).

A computing device (not illustrated) that may provide the computing device 200 of FIGS. 10A and 10B includes NICs 1104, 1106, 1108, and 1110 that may provide the NICs 204a, 204b, 204c, and 204d of FIGS. 10A and 10B (or that may provide the NICs 204e, 204f, 204g, and 204h of FIGS. 10A and 10B). In the illustrated embodiment, the NIC 1104 includes a pair of 200G ports 1104a and 1104b coupled to a 400G MAC 1104c, the NIC 1106 includes a pair of 200G ports 1106a and 1106b coupled to a 400G MAC 1106c, the NIC 1108 includes a pair of 200G ports 1108a and 1108b coupled to a 400G MAC 1108c, and the NIC 1110 includes a pair of 200G ports 1110a and 1110b coupled to a 400G MAC 11110c. A plurality of breakout cables 1112, 1114, 1116, and 1118 couple the 400G ports 1100a, 1100b, 1102a, and 1102b, respectively, to the NICs 1104, 1108, 1106, and 1110, respectively, and may provide the breakout cables 1000a, 1000b, 1000e, and 1000f of FIGS. 10A and 10B (or that may provide the breakout cables 1000c, 1000d, 1000g, and 1000h of FIGS. 10A and 10B).

As can be seen, the breakout cable 1112 includes a first connector 1112a connected to the 400G port 1100a, and a pair of second connectors 1112b and 1112c connected to the 200G ports 1104a and 1104b, respectively, to couple four of the eight 50G lanes (provided by the 400G MAC 1100c to the 200G port 1100a) from the 400G port 1100a to the 200G port 1104a (as illustrated by the four lines between the second connector 1112b and the 200G port 1104a in FIG. 11), and to couple the other four of the eight 50G lanes (provided by the 400G MAC 1100c to the 200G port 1100a) from the 400G port 1100a to the 200G port 1104b (as illustrated by the four lines between the second connector 1112c and the 200G port 1104b in FIG. 11), with four 50G lanes provided between the 200G port 1104a and the 400G MAC 1104c (as illustrated by the four lines between the 200G port 1104a and the 400G MAC 1104c in FIG. 11), and four 50G lanes provided between the 200G port 1104b and the 400G MAC 1104c (as illustrated by the four lines between the 200G port 1104b and the 400G MAC 1104c in FIG. 11).

Similarly, the breakout cable 1114 includes a first connector 1114a connected to the 400G port 1100b, and a pair of second connectors 1114b and 1114c connected to the 200G ports 1108a and 1108b, respectively, to couple four of the eight 50G lanes (provided by the 400G MAC 1100d to the 200G port 1100b) from the 400G port 1100b to the 200G port 1108a (as illustrated by the four lines between the second connector 1114b and the 200G port 1108a in FIG. 11), and to couple the other four of the eight 50G lanes (provided by the 400G MAC 1100d to the 200G port 1100b) from the 400G port 1100b to the 200G port 1108b (as illustrated by the four lines between the second connector 1114c and the 200G port 1108b in FIG. 11), with four 50G lanes provided between the 200G port 1108a and the 400G MAC 1108c (as illustrated by the four lines between the 200G port 1108a and the 400G MAC 1108c in FIG. 11), and four 50G lanes provided between the 200G port 1108b and the 400G MAC 1108c (as illustrated by the four lines between the 200G port 1108b and the 400G MAC 1108c in FIG. 11).

Similarly as well, the breakout cable 1116 includes a first connector 1116a connected to the 400G port 1102a, and a pair of second connectors 1116b and 1116c connected to the 200G ports 1106a and 1106b, respectively, to couple four of the eight 50G lanes (provided by the 400G MAC 1102c to the 200G port 1102a) from the 400G port 1102a to the 200G port 1106a (as illustrated by the four lines between the second connector 1116b and the 200G port 1106a in FIG. 11), and to couple the other four of the eight 50G lanes (provided by the 400G MAC 1102c to the 200G port 1102a) from the 400G port 1102a to the 200G port 1106b (as illustrated by the four lines between the second connector 1116c and the 200G port 1106b in FIG. 11), with four 50G lanes provided between the 200G port 1106a and the 400G MAC 1106c (as illustrated by the four lines between the 200G port 1106a and the 400G MAC 1106c in FIG. 11), and four 50G lanes provided between the 200G port 1106b and the 400G MAC 1106c (as illustrated by the four lines between the 200G port 1106b and the 400G MAC 1106c in FIG. 11).

Similarly as well, the breakout cable 1118 includes a first connector 1118a connected to the 400G port 1102b, and a pair of second connectors 1118b and 1118c connected to the 200G ports 1110a and 1110b, respectively, to couple four of the eight 50G lanes (provided by the 400G MAC 1102d to the 200G port 1102f) from the 400G port 1102b to the 200G port 1110a (as illustrated by the four lines between the second connector 1118b and the 200G port 1110a in FIG. 11), and to couple the other four of the eight 50G lanes from the 400G port 1102b to the 200G port 1110b (as illustrated by the four lines between the second connector 1118c and the 200G port 1110b in FIG. 11), with four 50G lanes provided between the 200G port 1110a and the 400G MAC 1110c (as illustrated by the four lines between the 200G port 1110a and the 400G MAC 1110c in FIG. 11), and four 50G lanes provided between the 200G port 1110b and the 400G MAC 1110c (as illustrated by the four lines between the 200G port 1110b and the 400G MAC 1110c in FIG. 11).

With reference to FIGS. 15A and 15B and a second implementation of the teachings of the present disclosure, in an embodiment of block 402, the computing device 200 may be coupled to the networking device 300 and a networking device 1500 (which is substantially similar to the networking device 300 as described above and includes a chassis 1502 and ports 1504a-1504i similar to the chassis 302 and the ports 304a-304i) to provide an Ethernet AI fabric configuration according to the teachings of the present disclosure that utilizes the “top/bottom” internal switch fabric scaling described above. As illustrated in FIG. 15A, a breakout cable 1500a may connect the port 304a on the networking device 300 to one of the ports (e.g., one of the pair of QSFP ports discussed above) on each of the NICs 204a and 204b, a breakout cable 1500b may connect the port 304c on the networking device 300 to the one of the ports (e.g., one of the pair of QSFP ports discussed above) on each of the NICs 204c and 204d, a breakout cable 1500c may connect the port 304e on the networking device 300 to one of the ports (e.g., one of the pair of QSFP ports discussed above) on each of the NICs 204e and 204f, and a breakout cable 1500d may connect the port 304g on the networking device 300 to one of the ports (e.g., one of the pair of QSFP ports discussed above) on each of the NICs 204g and 204h. Continuing with the intuitive naming conventions described above, the networking device 300 may be configured to provide access to a “top” fabric, and may have four of its ports 304a, 304c, 304e, and 304g connected via respective breakout cables 1500a, 1500b, 1500c, and 1500d to the “top” ports on each of the NIC pairs 204a/204b, 204c/204d, 204e/204f, and 204g/204h, respectively, on the computing device 200.

As illustrated in FIG. 15B, a breakout cable 1500e may connect the port 1504b on the networking device 1500 to one of the ports (e.g., one of the pair of QSFP ports discussed above) on each of the NICs 204a and 204b, a breakout cable 1500f may connect the port 1504d on the networking device 1500 to the one of the ports (e.g., one of the pair of QSFP ports discussed above) on each of the NICs 204c and 204d, a breakout cable 1500g may connect the port 1504g on the networking device 1500 to one of the ports (e.g., one of the pair of QSFP ports discussed above) on each of the NICs 204e and 204f, and a breakout cable 1500h may connect the port 1504h on the networking device 1500 to one of the ports (e.g., one of the pair of QSFP ports discussed above) on each of the NICs 204g and 204h. Continuing with the intuitive naming conventions described above, the networking device 1500 may be configured to provide access to a “bottom” fabric, and may have four of its ports 1504b, 1504d, 1504f, and 1504h connected via respective breakout cables 1500e, 1500f, 1500g, and 1500h to the “bottom” ports on each of the NIC pairs 204a/204b, 204c/204d, 204e/204f, and 204g/204h, respectively, on the computing device 200.

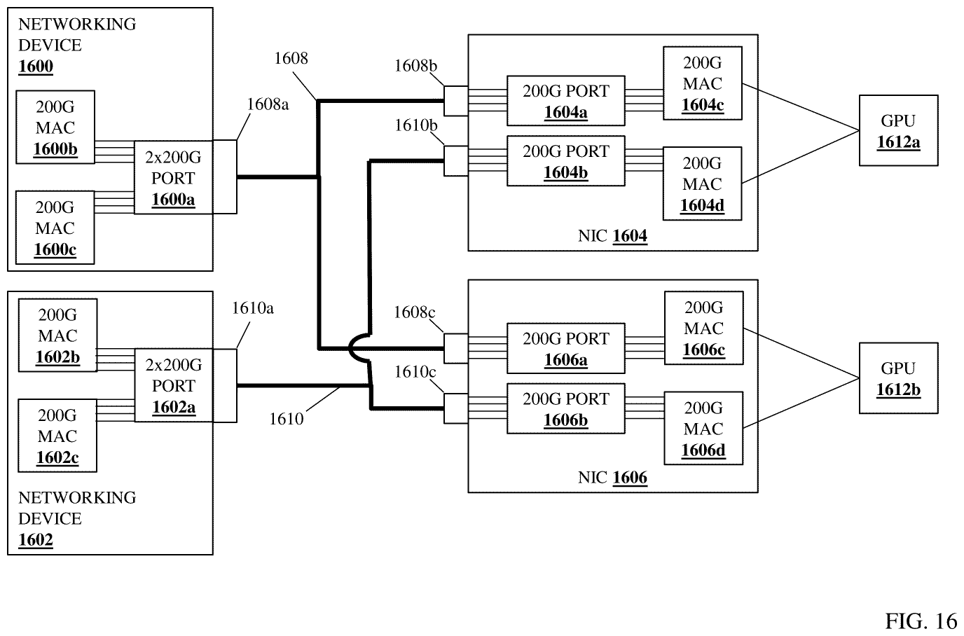

With reference to FIG. 16, a specific example of the networking device/NIC/GPU connections in the Ethernet AI fabric configuration of FIGS. 15A and 15B is illustrated. In the illustrated embodiment, a networking device 1500 is illustrated connected to a NIC in a computing device, a networking device 1602 is illustrated connected to a NIC in that computing device, and one of skill in the art in possession of the present disclosure will appreciate how FIG. 16 may illustrate the connection of the networking device 300 (provided by the networking device 1600) to the NICs 204a and 204b on the computing device 200 illustrated in FIG. 15A, and the connection of the networking device 1500 (provided by the networking device 1602) to the NICs 204a and 204b on the computing device 200 illustrated in FIG. 15B. Furthermore, one of skill in the art in possession of the present disclosure will also appreciate how FIG. 16 may also illustrate the connection of the networking device 300 (provided by the networking device 1600) and the networking device 1500 (provided by the networking device 1602) to the NICs 204c and 204d on the computing device 200 illustrated in FIGS. 15A and 15B, the connection of the networking device 300 (provided by the networking device 1600) and the networking device 1500 (provided by the networking device 1602) to the NICs 204e and 204f on the computing device 200 illustrated in FIGS. 15A and 15B, or the connection of the networking device 300 (provided by the networking device 1600) and the networking device 1500 (provided by the networking device 1602) to the NICs 204g and 204h on the computing device 200 illustrated in FIGS. 15A and 15B.

As illustrated, the networking device 1600 may include a 2×200G port 1600a that may provide the port 304a (or the port 304c, 304e, or 304g) on the networking device 300 of FIG. 15A, and the networking device 1602 may include a 2×200G port 1602a that may provide the port 1504b (or the port 1504d, 1504f, or 1504h) on the networking device 1500 of FIG. 15B. As will be appreciated by one of skill in the art in possession of the present disclosure, the networking device 1600 may include a pair of 200G MACs 1600b and 1600c each providing four 50G lanes to the 2×200G port 1600a (as illustrated by the four lines between the 200G MAC 1600b and the 2×200G port 1600a, as well as the four lines between the 200G MAC 1600c and the 2×200G port 1600a, in FIG. 16). Similarly, the networking device 1602 may include a pair of 200G MACs 1602b and 1602c each providing four 50G lanes to the 2×200G port 1602a (as illustrated by the four lines between the 200G MAC 1602b and the 2×200G port 1602a, as well as the four lines between the 200G MAC 1602c and the 2×200G port 1602a, in FIG. 16).

A computing device (not illustrated) that may provide the computing device 200 of FIGS. 15A and 15B includes NICs 1604 and 1606 that may provide the NICs 204a and 204b (or the NIC pair 204c/204d, 204e/204e, or 204g/204h) of FIGS. 15A and 15B. In the illustrated embodiment, the NIC 1604 includes a pair of 200G ports 1604a and 1604b coupled to respective 200G MACs 1604c and 1604d, and the NIC 1606 includes a pair of 200G ports 1606a and 1606b coupled to respective 200G MACs 1606c and 1606d. A plurality of breakout cables 1608 and 1610 couple the 2×200G ports 1600a and 1602a, respectively, to the NICs 1604 and 1606, respectively, and may provide the breakout cables 1500a and 1500e (or the breakout cable pair 1500b/1500f, 1500c/1500g, or 1500d/1500h) of FIGS. 15A and 15B.

As can be seen, the breakout cable 1608 includes a first connector 1608a connected to the 2×200G port 1600a, a second connector 1608b connected to the 200G port 1604a to couple the four 50G lanes (provided by the 200G MAC 1600b to the 2×200G port 1600a) from the 2×200G port 1600a to the 200G port 1604a (as illustrated by the four lines between the second connector 1608b and the 200G port 1604a in FIG. 16), and a second connector 1608c connected to the 200G port 1606a to couple the four 50G lanes (provided by the 200G MAC 1600c to the 2×200G port 1600a) from the 2×200G port 1600a to the 200G port 1606a (as illustrated by the four lines between the second connector 1608c and the 200G port 1606a in FIG. 16), with four 50G lanes provided between the 200G port 1604a and the 200G MAC 1604c (as illustrated by the four lines between the 200G port 1604a and the 200G MAC 1604c in FIG. 16), and four 50G lanes provided between the 200G port 1606a and the 200G MAC 1606c (as illustrated by the four lines between the 200G port 1606a and the 200G MAC 1606c in FIG. 16).

Similarly, the breakout cable 1610 includes a first connector 1610a connected to the 2×200G port 1602a, a second connector 1610b connected to the 200G port 1604b to couple the four 50G lanes (provided by the 200G MAC 1602b to the 2×200G port 1602a) from the 2×200G port 1602a to the 200G port 1604b (as illustrated by the four lines between the second connector 1610b and the 200G port 1604b in FIG. 16), and a second connector 1610c connected to the 200G port 1606b to couple the four 50G lanes (provided by the 200G MAC 1602c to the 2×200G port 1602a) from the 2×200G port 1602a to the 200G port 1606b (as illustrated by the four lines between the second connector 1610c and the 200G port 1606b in FIG. 16), with four 50G lanes provided between the 200G port 1604b and the 200G MAC 1604d (as illustrated by the four lines between the 200G port 1604b and the 200G MAC 1604d in FIG. 16), and four 50G lanes provided between the 200G port 1606b and the 200G MAC 1606d (as illustrated by the four lines between the 200G port 1606b and the 200G MAC 1606d in FIG. 16).

With reference to FIGS. 20A, 20B, 20C, and 20D and a third implementation of the teachings of the present disclosure, in an embodiment of block 402, the computing device 200 may be coupled to the networking device 300, a networking device 2000 (which is substantially similar to the networking device 300 as described above and includes a chassis 2002 and ports 2004a-2004i similar to the chassis 302 and the ports 304a-304i), a networking device 2006 (which is substantially similar to the networking device 300 as described above and includes a chassis 2008 and ports 2010a-2010i similar to the chassis 302 and the ports 304a-304i), and a networking device 2012 (which is substantially similar to the networking device 300 as described above and includes a chassis 2014 and ports 2016a-2016i similar to the chassis 302 and the ports 304a-304i), to provide an Ethernet AI fabric configuration according to the teachings of the present disclosure that utilizes the “top/odd”, “top/even”, “bottom/odd”, “bottom/even” internal switch fabric scaling described above. As illustrated in FIG. 20A, a breakout cable 2000a may connect the port 304a on the networking device 300 to one of the ports (e.g., one of the pair of QSFP ports discussed above) on each of the NICs 204a and 204c, and a breakout cable 2000b may connect the port 304e on the networking device 300 to the one of the ports (e.g., one of the pair of QSFP ports discussed above) on each of the NICs 204e and 204g. Continuing with the intuitive naming conventions described above, the networking device 300 may be configured to provide access to a “top/odd” fabric, and may have two of its ports 304a and 304e connected via respective breakout cables 2000a and 2000b to the “top” ports on respective pairs of the “odd” NICs (i.e., with the breakout cable 2000a connected to the “top” ports on the “first” NIC 204a and the “third” NIC 204c, and with the breakout cable 2000b connected to the “top” ports on the “fifth” NIC 204e and the “seventh” NIC 204g) on the computing device 200.

As illustrated in FIG. 20B, a breakout cable 2000c may connect the port 2004b on the networking device 2000 to one of the ports (e.g., one of the pair of QSFP ports discussed above) on each of the NICs 204b and 204d, and a breakout cable 2000d may connect the port 2004f on the networking device 2000 to the one of the ports (e.g., one of the pair of QSFP ports discussed above) on each of the NICs 204f and 204h. Continuing with the intuitive naming conventions described above, the networking device 2000 may be configured to provide access to a “top/even” fabric, and may have two of its ports 2004b and 2004f connected via respective breakout cables 2000c and 2000d to the “top” ports on respective pairs of the “even” NICs (i.e., with the breakout cable 2000c connected to the “top” ports on the “second” NIC 204b and the “fourth” NIC 204d, and with the breakout cable 2000d connected to the “top” ports on the “sixth” NIC 204f and the “eighth” NIC 204h) on the computing device 200.

As illustrated in FIG. 20C, a breakout cable 2000e may connect the port 2010a on the networking device 2006 to one of the ports (e.g., one of the pair of QSFP ports discussed above) on each of the NICs 204a and 204c, and a breakout cable 2000f may connect the port 2010e on the networking device 2006 to the one of the ports (e.g., one of the pair of QSFP ports discussed above) on each of the NICs 204e and 204g. Continuing with the intuitive naming conventions described above, the networking device 2006 may be configured to provide access to a “bottom/odd” fabric, and may have two of its ports 2010a and 2010e connected via respective breakout cables 2000e and 2000f to the “bottom” ports on respective pairs of the “odd” NICs (i.e., with the breakout cable 2000e connected to the “bottom” ports on the “first” NIC 204a and the “third” NIC 204c, and with the breakout cable 2000f connected to the “bottom” ports on the “fifth” NIC 204e and the “seventh” NIC 204g) on the computing device 200.

As illustrated in FIG. 20D, a breakout cable 2000g may connect the port 2016b on the networking device 2012 to one of the ports (e.g., one of the pair of QSFP ports discussed above) on each of the NICs 204b and 204d, and a breakout cable 2000h may connect the port 2016f on the networking device 2012 to the one of the ports (e.g., one of the pair of QSFP ports discussed above) on each of the NICs 204f and 204h. Continuing with the intuitive naming conventions described above, the networking device 2012 may be configured to provide access to a “bottom/even” fabric, and may have two of its ports 2016b and 2016f connected via respective breakout cables 2000g and 2000h to the “bottom” ports on respective pairs of the “even” NICs (i.e., with the breakout cable 2000g connected to the “bottom” ports on the “second” NIC 204b and the “fourth” NIC 204d, and with the breakout cable 2000h connected to the “bottom” ports on the “sixth” NIC 204f and the “eighth” NIC 204h) on the computing device 200.

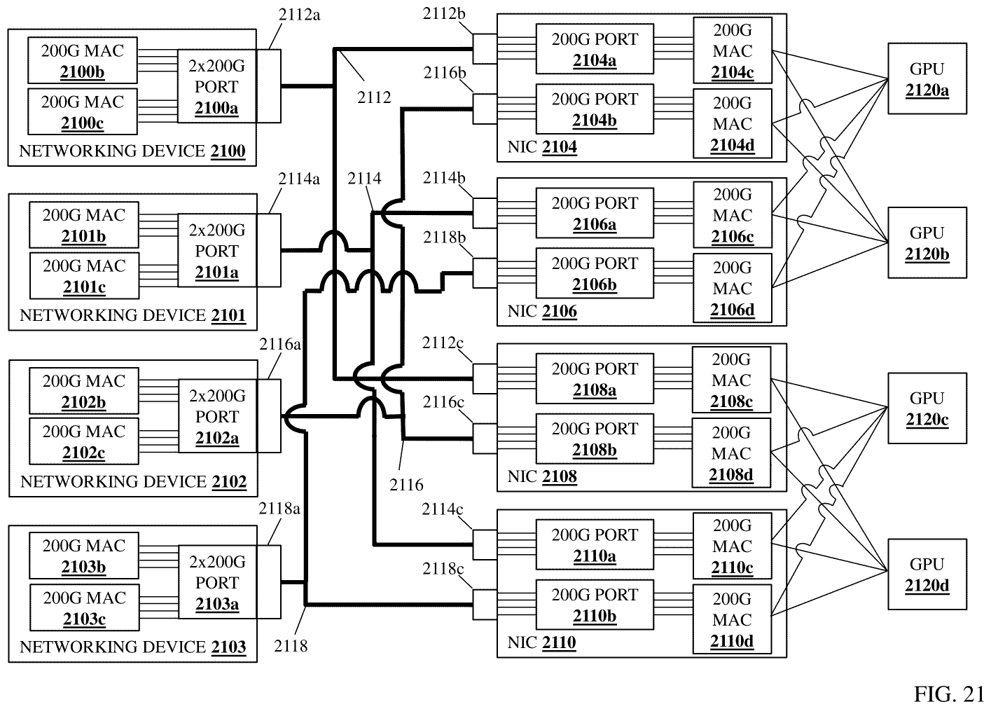

With reference to FIG. 21, a specific example of the networking device/NIC/GPU connections in the Ethernet AI fabric configuration of FIGS. 20A, 20B, 20C, and 20D is illustrated. In the illustrated embodiment, a networking device 2100 is illustrated connected to NICs in a computing device, a networking device 2101 is illustrated connected to NICs in that computing device, a networking device 2102 is illustrated connected to NICs in that computing device, a networking device 2103 is illustrated connected to NICs in that computing device, and one of skill in the art in possession of the present disclosure will appreciate how FIG. 21 may illustrate the connection of the networking device 300 (provided by the networking device 2100) to the NICs 204a and 204c on the computing device 200 illustrated in FIG. 20A, the connection of the networking device 2000 (provided by the networking device 2101) to the NICs 204b and 204d on the computing device 200 illustrated in FIG. 20B, the connection of the networking device 2006 (provided by the networking device 2102) to the NICs 204a and 204c on the computing device 200 illustrated in FIG. 20C, and the connection of the networking device 2012 (provided by the networking device 2103) to the NICs 204b and 204d on the computing device 200 illustrated in FIG. 20D.

Furthermore, one of skill in the art in possession of the present disclosure will also appreciate how FIG. 21 may also illustrate the connection of the networking device 300 (provided by the networking device 2100) to the NICs 204e and 204g on the computing device 200 illustrated in FIG. 20A, the connection of the networking device 2000 (provided by the networking device 2101) to the NICs 204f and 204h on the computing device 200 illustrated in FIG. 20B, the connection of the networking device 2006 (provided by the networking device 2102) to the NICs 204e and 204g on the computing device 200 illustrated in FIG. 20C, and the connection of the networking device 2012 (provided by the networking device 2103) to the NICs 204f and 204h on the computing device 200 illustrated in FIG. 20D.

As illustrated, the networking device 2100 may include a 2×200G port 2100a that may provide the port 304a (or the port 304e) on the networking device 300 of FIG. 20A, the networking device 2101 may include a 2×200G port 2101a that may provide the port 2004b (or the port 2004f) on the networking device 2000 of FIG. 20B, the networking device 2102 may include a 2×200G port 2102a that may provide the port 2010a (or the port 2010e) on the networking device 2006 of FIG. 20C, and the networking device 2103 may include a 2×200G port 2103a that may provide the port 2016b (or the port 2016f) on the networking device 2012 of FIG. 20D. As will be appreciated by one of skill in the art in possession of the present disclosure, the networking device 2100 may include a pair of 200G MACs 2100b and 2100c each providing four 50G lanes to the 2×200G port 2100a (as illustrated by the four lines between the 200G MAC 2100b and the 2×200G port 2100a, as well as the four lines between the 200G MAC 2100c and the 2×200G port 2100a, in FIG. 21).

Similarly, the networking device 2101 may include a pair of 200G MACs 2101b and 2101c each providing four 50G lanes to the 2×200G port 2101a (as illustrated by the four lines between the 200G MAC 2101b and the 2×200G port 2101a, as well as the four lines between the 200G MAC 2101c and the 2×200G port 2101a, in FIG. 21). Similarly as well, the networking device 2102 may include a pair of 200G MACs 2102b and 2102c each providing four 50G lanes to the 2×200G port 2102a (as illustrated by the four lines between the 200G MAC 2102b and the 2×200G port 2102a, as well as the four lines between the 200G MAC 2102c and the 2×200G port 2102a, in FIG. 21). Similarly as well, the networking device 2103 may include a pair of 200G MACs 2103b and 2103c each providing four 50G lanes to the 2×200G port 2103a (as illustrated by the four lines between the 200G MAC 2103b and the 2×200G port 2103a, as well as the four lines between the 200G MAC 2103c and the 2×200G port 2103a, in FIG. 21).

A computing device (not illustrated) that may provide the computing device 200 of FIGS. 20A, 20B, 20C, and 20D includes NICs 2104, 2106, 2108, and 2110 that may provide the NICs 204a, 204b, 204c, and 204d (or the NICs 204e, 204f, 204g, and 204h) of FIGS. 20A, 20B, 20C, and 20D. In the illustrated embodiment, the NIC 2104 includes a pair of 200G ports 2104a and 2104b coupled to respective 200G MACs 2104c and 2104d, the NIC 2106 includes a pair of 200G ports 2106a and 2106b coupled to respective 200G MACs 2106c and 2106d, the NIC 2108 includes a pair of 200G ports 2108a and 2108b coupled to respective 200G MACs 2108c and 2108d, and the NIC 2110 includes a pair of 200G ports 2110a and 2110b coupled to respective 200G MACs 2110c and 2110d. A plurality of breakout cables 2112, 2114, 2116, and 2118 couple the 2×200G ports 2100a, 2101a, 2102a, and 2103a, respectively, to the NICs 2104/2108, 2106/2110, 2104/2108, and 2106/2110, respectively, and may provide the breakout cables 2000a, 2000c, 2000e and 2000g (or the breakout cables 2000b, 2000d, 2000f, and 2000h) of FIGS. 20A, 20B, 20C, and 20D.

As can be seen, the breakout cable 2112 includes a first connector 2112a connected to the 2×200G port 2100a, a second connector 2112b connected to the 200G port 2104a to couple the four 50G lanes (provided by the 200G MAC 2100b to the 2×200G port 2100a) from the 2×200G port 2100a to the 200G port 2104a (as illustrated by the four lines between the second connector 2112b and the 200G port 2104a in FIG. 21), and a second connector 2112c connected to the 200G port 2108a to couple the four 50G lanes (provided by the 200G MAC 2100c to the 2×200G port 2100a) from the 2×200G port 2100a to the 200G port 2108a (as illustrated by the four lines between the second connector 2112c and the 200G port 2108a in FIG. 21), with four 50G lanes provided between the 200G port 2104a and the 200G MAC 2104c (as illustrated by the four lines between the 200G port 2104a and the 200G MAC 2104c in FIG. 21), and four 50G lanes provided between the 200G port 2108a and the 200G MAC 2108c (as illustrated by the four lines between the 200G port 2108a and the 200G MAC 2108c in FIG. 21).

Similarly, the breakout cable 2114 includes a first connector 2114a connected to the 2×200G port 2101a, a second connector 2114b connected to the 200G port 2106a to couple the four 50G lanes (provided by the 200G MAC 2101b to the 2×200G port 2101a) from the 2×200G port 2101a to the 200G port 2106a (as illustrated by the four lines between the second connector 2114b and the 200G port 2106a in FIG. 21), and a second connector 2114c connected to the 200G port 2110a to couple the four 50G lanes (provided by the 200G MAC 2101c to the 2×200G port 2101a) from the 2×200G port 2101a to the 200G port 2110a (as illustrated by the four lines between the second connector 2114c and the 200G port 2110a in FIG. 21), with four 50G lanes provided between the 200G port 2106a and the 200G MAC 2106c (as illustrated by the four lines between the 200G port 2106a and the 200G MAC 2106c in FIG. 21), and four 50G lanes provided between the 200G port 2110a and the 200G MAC 2110c (as illustrated by the four lines between the 200G port 2110a and the 200G MAC 2110c in FIG. 21).

Similarly as well, the breakout cable 2116 includes a first connector 2116a connected to the 2×200G port 2102a, a second connector 2116b connected to the 200G port 2104b to couple the four 50G lanes (provided by the 200G MAC 2102b to the 2×200G port 2102a) from the 2×200G port 2102a to the 200G port 2104b (as illustrated by the four lines between the second connector 2116b and the 200G port 2104b in FIG. 21), and a second connector 2116c connected to the 200G port 2108b to couple the four 50G lanes (provided by the 200G MAC 2102c to the 2×200G port 2102a) from the 2×200G port 2102a to the 200G port 2108b (as illustrated by the four lines between the second connector 2116c and the 200G port 2108b in FIG. 21), with four 50G lanes provided between the 200G port 2104b and the 200G MAC 2104d (as illustrated by the four lines between the 200G port 2104b and the 200G MAC 2104d in FIG. 21), and four 50G lanes provided between the 200G port 2108b and the 200G MAC 2108d (as illustrated by the four lines between the 200G port 2108b and the 200G MAC 2108d in FIG. 21).

Similarly as well, the breakout cable 2118 includes a first connector 2118a connected to the 2×200G port 2103a, a second connector 2118b connected to the 200G port 2106b to couple the four 50G lanes (provided by the 200G MAC 2103b to the 2×200G port 2103a) from the 2×200G port 2103a to the 200G port 2106b (as illustrated by the four lines between the second connector 2118b and the 200G port 2106b in FIG. 21), and a second connector 2118c connected to the 200G port 2110b to couple the four 50G lanes (provided by the 200G MAC 2103c to the 2×200G port 2103a) from the 2×200G port 2103a to the 200G port 2110b (as illustrated by the four lines between the second connector 2118c and the 200G port 2110b in FIG. 21), with four 50G lanes provided between the 200G port 2106b and the 200G MAC 2106d (as illustrated by the four lines between the 200G port 2106b and the 200G MAC 2106d in FIG. 21), and four 50G lanes provided between the 200G port 2110b and the 200G MAC 2110d (as illustrated by the four lines between the 200G port 2110b and the 200G MAC 2110d in FIG. 21).

The method 400 then proceeds to block 404 where an internal switch fabric in the computing device is configured to couple a plurality of GPUs in the computing device to the plurality of NICs in the computing device to provide each of the plurality of GPUs in the computing device access to each of the plurality of external fabrics. As will be appreciated by one of skill in the art in possession of the present disclosure, the internal switch fabric 208 in any of the computing devices 200 discussed below may be configured as described below by a server administrator based on the Ethernet AI fabric configuration provided by a network administrator, may be configured automatically based on the detection of the Ethernet AI fabric configuration to which that computing device is connected, and/or any be configured in a variety of other manners that will fall within the scope of the present disclosure. Furthermore, one of skill in the art in possession of the present disclosure will appreciate how software libraries (e.g., the NVIDIA® Collective Communication Library (NCCL), the ROCm Collective Communication Library (RCCL), etc.) provided for the computing devices 200 and the Ethernet AI fabrics described herein may be configured to hide multiple paths provided for any GPU to the AI applications provided by that GPU.

Returning to the example of the first implementation of the teachings of the present disclosure introduced above, in an embodiment of block 404, the internal switch fabric 208 in the computing device 200 may be configured to provide the “odd/even” internal switch fabric scaling described above. With reference to FIG. 11, the internal switch fabric (not illustrated, but which may provide the internal switch fabric 208 of FIGS. 10A and 10B) is configured with a 1-to-2 GPU-to-NIC mapping between a GPU 1120a that may provide the GPU 206a (or the GPU 206e) of FIGS. 10A and 10B, and each of the 400G MAC 1104c in the NIC 1104 and the 400G MAC 1106c in the NIC 1106. Similarly, the internal switch fabric (not illustrated, but which may provide the internal switch fabric 208 of FIGS. 10A and 10B) is configured with a 1-to-2 GPU-to-NIC mapping between a GPU 1120b that may provide the GPU 206b (or the GPU 206f) of FIGS. 10A and 10B, and each of the 400G MAC 1104c in the NIC 1104 and the 400G MAC 1106c in the NIC 1106. As such, one of skill in the art in possession of the present disclosure will appreciate how each of the GPUs 1120a and 1120b is provided with an aggregated 400G connectivity to the fabrics accessible via each of the networking devices 1100 and 1102 (e.g., the “odd” fabric accessible via the networking device 300/1100, and the “even” fabric accessible via the networking device 1000/1102) via two shared 400G paths (i.e., with the 400G path provided by each of the 400G MACs 1104c and 1106c shared by the GPUs 1120a and 1120b).

With continued reference to FIG. 11, the internal switch fabric (not illustrated, but which may provide the internal switch fabric 208 of FIGS. 10A and 10B) is configured with a 1-to-2 GPU-to-NIC mapping between a GPU 1120c that may provide the GPU 206c (or the GPU 206g) of FIGS. 10A and 10B, and each of the 400G MAC 1108c in the NIC 1108 and the 400G MAC 1110c in the NIC 1110. Similarly, the internal switch fabric (not illustrated, but which may provide the internal switch fabric 208 of FIGS. 10A and 10B) is configured with a 1-to-2 GPU-to-NIC mapping between a GPU 1120d that may provide the GPU 206d (or the GPU 206h) of FIGS. 10A and 10B, and each of the 400G MAC 1108c in the NIC 1108 and the 400G MAC 1110c in the NIC 1110. As such, one of skill in the art in possession of the present disclosure will appreciate how each of the GPUs 1120c and 1120d is provided with an aggregated 400G connectivity to the fabrics accessible via each of the networking devices 1100 and 1102 (e.g., the “odd” fabric accessible via the networking device 300/1100, and the “even” fabric accessible via the networking device 1000/1102) via two shared 400G paths (i.e., with the 400G path provided by each of the 400G MACs 1108c and 1110c shared by the GPUs 1120c and 1120d).

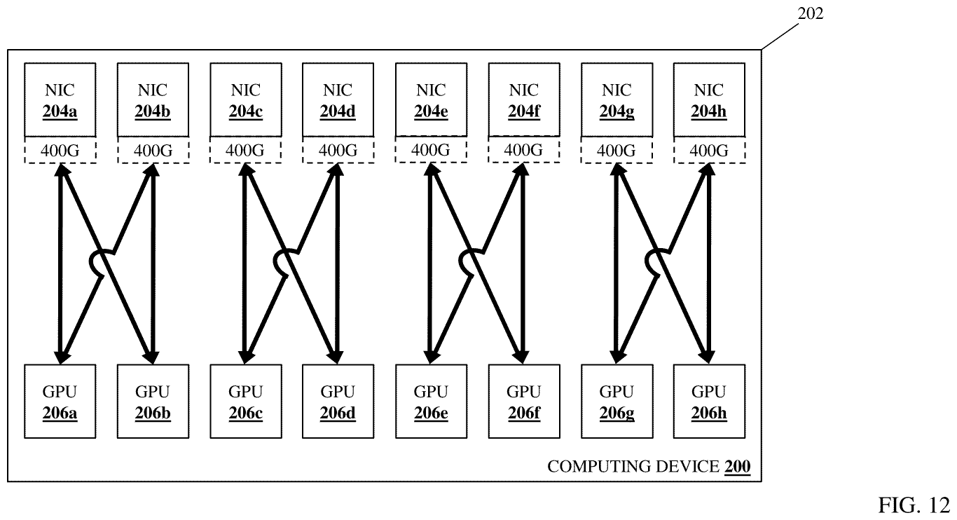

With reference to FIG. 12, the 1-to-2 GPU-to-NIC mappings provided by the internal switch fabric 208 (not illustrated in FIG. 12 for clarity) between the GPUs 206a-206h and the NICs 204a-204h, respectively, in the Ethernet AI fabric configuration of FIGS. 10A and 10B is illustrated, with a 1-to-2 GPU-to-NIC mapping provided by the switch device 208a enabling shared 400G paths between the GPU 206a and the NIC set provided by the NICs 204a and 204b to provide the GPU 206a with 400G connectivity, a 1-to-2 GPU-to-NIC mapping provided by the switch device 208a enabling shared 400G paths between the GPU 206b and the NIC set provided by the NICs 204a and 204b to provide the GPU 206b with 400G connectivity, a 1-to-2 GPU-to-NIC mapping provided by the switch device 208b enabling shared 400G paths between the GPU 206c and the NIC set provided by the NICs 204c and 204d to provide the GPU 206c with 400G connectivity, a 1-to-2 GPU-to-NIC mapping provided by the switch device 208b enabling shared 400G paths between the GPU 206d and the NIC set provided by the NICs 204c and 204d to provide the GPU 206d with 400G connectivity, a 1-to-2 GPU-to-NIC mapping provided by the switch device 208c enabling shared 400G paths between the GPU 206e and the NIC set provided by the NICs 204e and 204f to provide the GPU 206e with 400G connectivity, a 1-to-2 GPU-to-NIC mapping provided by the switch device 208c enabling shared 400G paths between the GPU 206f and the NIC set provided by the NICs 204e and 204f to provide the GPU 206f with 400G connectivity, a 1-to-2 GPU-to-NIC mapping provided by the switch device 208d enabling shared 400G paths between the GPU 206g and the NIC set provided by the NICs 204g and 204h to provide the GPU 206g with 400G connectivity, and a 1-to-2 GPU-to-NIC mapping provided by the switch device 208d enabling shared 400G paths between the GPU 206h and the NIC set provided by the NICs 204g and 204h to provide the GPU 206h with 400G connectivity. However, while a specific 1-to-2 GPU-to-NIC mapping is illustrated, mappings with more GPUs to NICs, or a single GPU to multiple NICs, will fall within the scope of the present disclosure as well.

Returning to the example of the second implementation of the teachings of the present disclosure introduced above, in an embodiment of block 404, the internal switch fabric 208 in the computing device 200 may be configured to provide the “top/bottom” internal switch fabric scaling described above. With reference to FIG. 16, the internal switch fabric (not illustrated, but which may provide the internal switch fabric 208 of FIGS. 15A and 15B) is configured with a 1-to-2 GPU-to-NIC mapping between a GPU 1612a that may provide the GPU 206a (or the GPU 206c, 206e, or 206g) of FIGS. 15A and 15B, and each of the 200G MAC 1604c and the 200G MAC 1604d in the NIC 1604. Similarly, the internal switch fabric (not illustrated, but which may provide the internal switch fabric 208 of FIGS. 10A and 10B) is configured with a 1-to-2 GPU-to-NIC mapping between a GPU 1612b that may provide the GPU 206b (or the GPU 206d, 206f, or 206h) of FIGS. 15A and 15B, and each of the 200G MAC 1606c and the 200G MAC 1606d in the NIC 1606. As such, one of skill in the art in possession of the present disclosure will appreciate how each of the GPUs 1612a and 1612b is provided with an aggregated 400G connectivity to the fabrics accessible via each of the networking devices 1600 and 1602 (e.g., the “odd” fabric accessible via the networking device 300/1600, and the “even” fabric accessible via the networking device 1500/1602) via two parallel 200G paths.

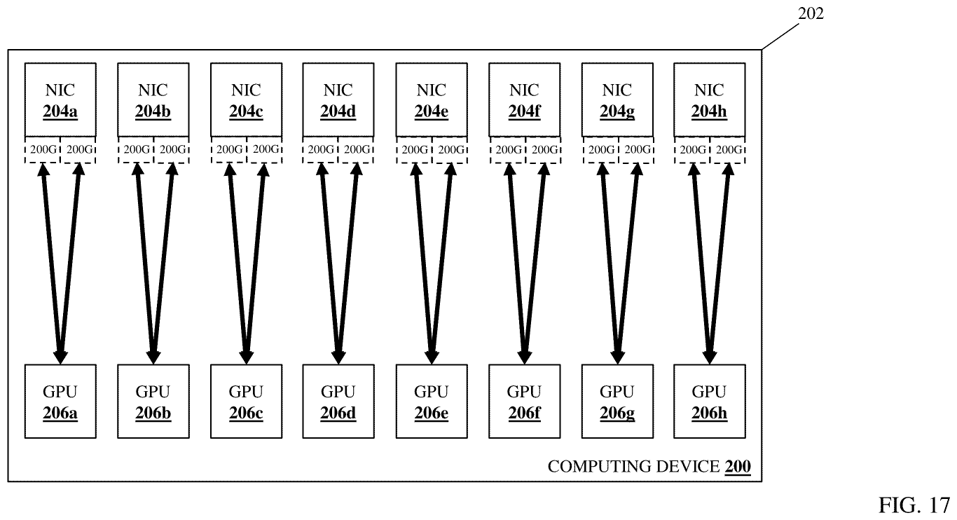

With reference to FIG. 17, the 1-to-2 GPU-to-NIC mappings provided by the internal switch fabric 208 (not illustrated in FIG. 17 for clarity) between the GPUs 206a-206h and the NICs 204a-204h, respectively, in the Ethernet AI fabric configuration of FIGS. 15A and 15B is illustrated, with a 1-to-2 GPU-to-NIC mapping provided by the switch device 208a enabling parallel 200G paths between the GPU 206a and the NIC set provided by the NIC 204a to provide the GPU 206a with 400G connectivity, a 1-to-2 GPU-to-NIC mapping provided by the switch device 208a enabling parallel 200G paths between the GPU 206b and the NIC set provided by the NIC 204b to provide the GPU 206b with 400G connectivity, a 1-to-2 GPU-to-NIC mapping provided by the switch device 208b enabling parallel 200G paths between the GPU 206c and the NIC set provided by the NIC 204c to provide the GPU 206c with 400G connectivity, a 1-to-2 GPU-to-NIC mapping provided by the switch device 208b enabling parallel 200G paths between the GPU 206d and the NIC set provided by the NIC 204d to provide the GPU 206d with 400G connectivity, a 1-to-2 GPU-to-NIC mapping provided by the switch device 208c enabling parallel 200G paths between the GPU 206e and the NIC set provided by the NIC 204e to provide the GPU 206e with 400G connectivity, a 1-to-2 GPU-to-NIC mapping provided by the switch device 208c enabling parallel 200G paths between the GPU 206f and the NIC set provided by the NIC 204f to provide the GPU 206f with 400G connectivity, a 1-to-2 GPU-to-NIC mapping provided by the switch device 208d enabling parallel 200G paths between the GPU 206g and the NIC set provided by the NIC 204g to provide the GPU 206g with 400G connectivity, and a 1-to-2 GPU-to-NIC mapping provided by the switch device 208d enabling parallel 200G paths between the GPU 206h and the NIC set provided by the NIC 204h to provide the GPU 206h with 400G connectivity. However, while a specific 1-to-2 GPU-to-NIC mapping is illustrated, mappings with more GPUs to NICs, or a single GPU to multiple NICs, will fall within the scope of the present disclosure as well.

Returning to the example of the third implementation of the teachings of the present disclosure introduced above, in an embodiment of block 404, the internal switch fabric 208 in the computing device 200 may be configured to provide the “top/odd”, “top/even”, “bottom/odd”, “bottom/even” internal switch fabric scaling described above. With reference to FIG. 21, the internal switch fabric (not illustrated, but which may provide the internal switch fabric 208 of FIGS. 20A, 20B, 20C, and 20D) is configured with a 1-to-4 GPU-to-NIC mapping between a GPU 2120a that may provide the GPU 206a (or the GPU 206e) of FIGS. 20A, 20B, 20C, and 20D, and each of the 200G MAC 2104c and the 200G MAC 2104d in the NIC 2104, and the 200G MAC 2106c and the 200G MAC 2106d in the NIC 2106. Similarly, the internal switch fabric (not illustrated, but which may provide the internal switch fabric 208 of FIGS. 20A, 20B, 20C, and 20D) is configured with a 1-to-4 GPU-to-NIC mapping between a GPU 2120b that may provide the GPU 206b (or the GPU 206f) of FIGS. 20A, 20B, 20C, and 20D, and each of the 200G MAC 2104c and the 200G MAC 2104d in the NIC 2104, and the 200G MAC 2106c and the 200G MAC 2106d in the NIC 2106. As such, one of skill in the art in possession of the present disclosure will appreciate how each of the GPUs 2120a and 2120b is provided with an aggregated 400G connectivity to the fabrics accessible via each of the networking devices 2100, 2101, 2102, and 2103 (e.g., the “top/odd” fabric accessible via the networking device 300/2100, the “top/even” fabric accessible via the networking device 2000/2101, the “bottom/odd” fabric accessible via the networking device 2006/2102, and the “bottom/even” fabric accessible via the networking device 2112/2103) via four shared 200G paths (i.e., with the 200G path provided by each of the 400G MACs 2104c, 2104d, 2106c, and 2106d shared by the GPUs 2120a and 2120b).

With continued reference to FIG. 21, the internal switch fabric (not illustrated, but which may provide the internal switch fabric 208 of FIGS. 20A, 20B, 20C, and 20D) is configured with a 1-to-4 GPU-to-NIC mapping between a GPU 2120c that may provide the GPU 206c (or the GPU 206g) of FIGS. 20A, 20B, 20C, and 20D, and each of the 200G MAC 2108c and the 200G MAC 2108d in the NIC 2108, and the 200G MAC 2110c and the 200G MAC 2110d in the NIC 2110. Similarly, the internal switch fabric (not illustrated, but which may provide the internal switch fabric 208 of FIGS. 20A, 20B, 20C, and 20D) is configured with a 1-to-4 GPU-to-NIC mapping between a GPU 2120d that may provide the GPU 206d (or the GPU 206h) of FIGS. 20A, 20B, 20C, and 20D, and each of the 200G MAC 2108c and the 200G MAC 2108d in the NIC 2108, and the 200G MAC 2110c and the 200G MAC 2110d in the NIC 2110. As such, one of skill in the art in possession of the present disclosure will appreciate how each of the GPUs 2120c and 2120d is provided with an aggregated 400G connectivity to the fabrics accessible via each of the networking devices 2100, 2101, 2102, and 2103 (e.g., the “top/odd” fabric accessible via the networking device 300/2100, the “top/even” fabric accessible via the networking device 2000/2101, the “bottom/odd” fabric accessible via the networking device 2006/2102, and the “bottom/even” fabric accessible via the networking device 2112/2103) via four shared 200G paths (i.e., with the 200G path provided by each of the 400G MACs 2108c, 2108d, 2110c, and 2110d shared by the GPUs 2120c and 2120d).

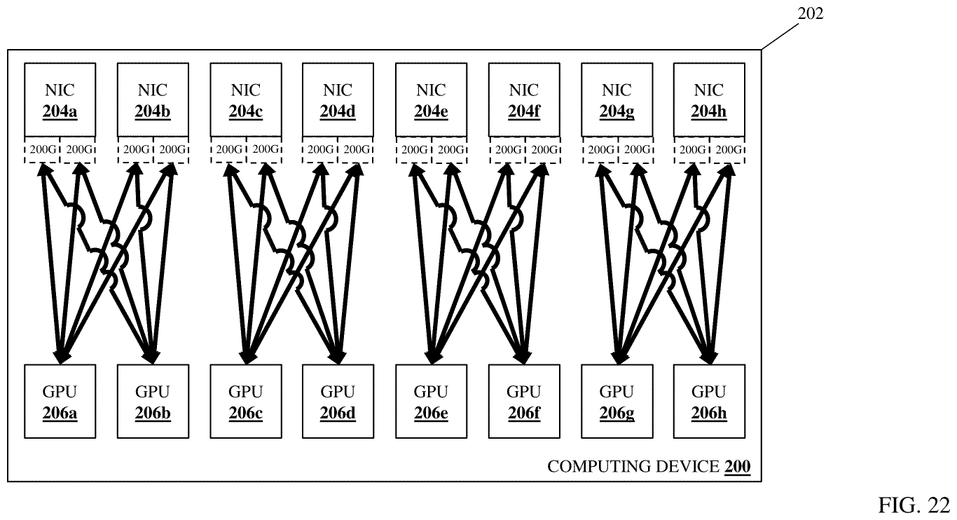

With reference to FIG. 22, the 1-to-4 GPU-to-NIC mappings provided by the internal switch fabric 208 (not illustrated in FIG. 21 for clarity) between the GPUs 206a-206h and the NICs 204a-204h, respectively, in the Ethernet AI fabric configuration of FIGS. 20A, 20B, 20C, and 20D is illustrated, with a 1-to-4 GPU-to-NIC mapping provided by the switch device 208a enabling shared 200G paths between the GPU 206a and the NIC set provided by the NICs 204a and 204b to provide the GPU 206a with 400G connectivity, a 1-to-4 GPU-to-NIC mapping provided by the switch device 208a enabling shared 200G paths between the GPU 206b and the NIC set provided by the NICs 204a and 204b to provide the GPU 206b with 400G connectivity, a 1-to-4 GPU-to-NIC mapping provided by the switch device 208b enabling shared 200G paths between the GPU 206c and the NIC set provided by the NICs 204c and 204d to provide the GPU 206c with 400G connectivity, a 1-to-4 GPU-to-NIC mapping provided by the switch device 208b enabling shared 200G paths between the GPU 206d and the NIC set provided by the NICs 204c and 204d to provide the GPU 206d with 400G connectivity, a 1-to-4 GPU-to-NIC mapping provided by the switch device 208c enabling shared 200G paths between the GPU 206e and the NIC set provided by the NICs 204e and 204f to provide the GPU 206e with 400G connectivity, a 1-to-4 GPU-to-NIC mapping provided by the switch device 208c enabling shared 200G paths between the GPU 206f and the NIC set provided by the NICs 204e and 204f to provide the GPU 206f with 400G connectivity, a 1-to-4 GPU-to-NIC mapping provided by the switch device 208d enabling shared 200G paths between the GPU 206g and the NIC set provided by the NICs 204g and 204h to provide the GPU 206g with 400G connectivity, and a 1-to-4 GPU-to-NIC mapping provided by the switch device 208d enabling shared 200G paths between the GPU 206h and the NIC set provided by the NICs 204g and 204h to provide the GPU 206h with 400G connectivity. However, while a specific 1-to-4 GPU-to-NIC mapping is illustrated, mappings with more (or fewer) GPUs to NICs, or a single GPU to multiple NICs, will fall within the scope of the present disclosure as well.

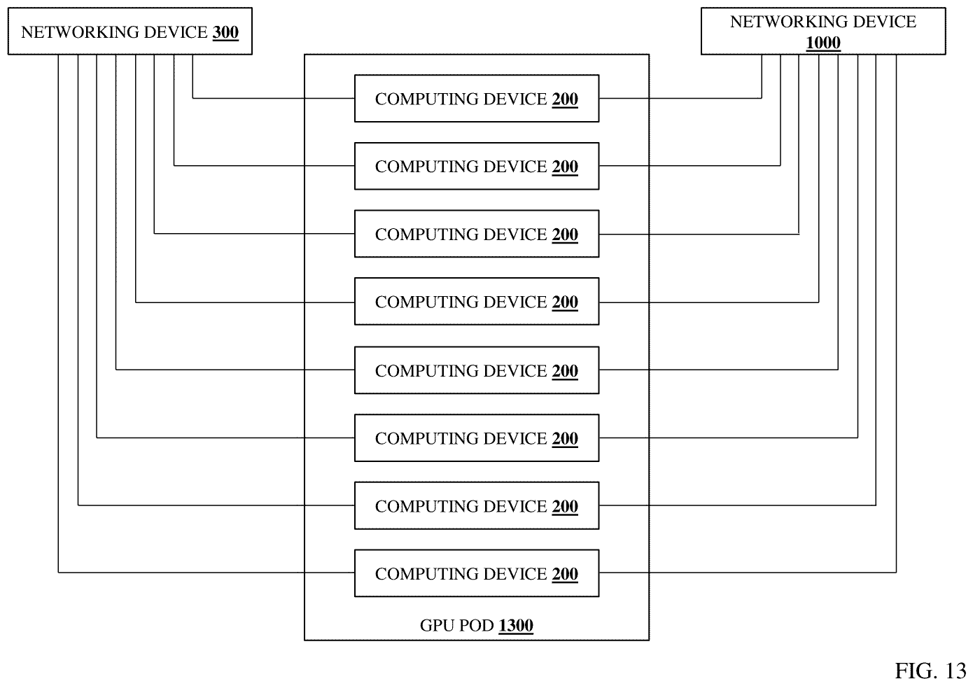

The method 400 then proceeds to block 406 where a first GPU in the computing device communicates with a second GPU using the plurality of external fabrics. Returning to the example of the first implementation of the teachings of the present disclosure provided above, in an embodiment of block 406, GPUs in computing devices included in the Ethernet AI fabric configuration of the present disclosure that utilizes the “odd/even” internal switch fabric scaling described above may communicate with each other. With reference to FIG. 13, a GPU “pod” 1300 may be defined in the Ethernet AI fabric configuration of FIGS. 10A and 10B, and may be provided by connecting eight of the computing devices 200 discussed above to each of the networking device 300 and the networking device 1000 discussed above (i.e., doubling the number of computing devices 200 that may be connected to a networking device to relative to the conventional GPU “pod” 800 discussed above with reference to FIG. 8).

For example, the networking devices 300 and 1000 of FIG. 13 may each include 64 ports, with 4 of the 64 ports on each of the networking device 300 and the networking device 1000 coupled to a first of the computing devices 200 in the GPU pod 1300 (e.g., the “top” computing device 200 in FIG. 13) similarly as described above with reference to FIGS. 10A and 10B, 4 of the 64 ports on each of the networking device 300 and the networking device 1000 coupled to a second of the computing devices 200 in the GPU pod 1300 (e.g., the “second from the top” computing device 200 in FIG. 13) similarly as described above with reference to FIGS. 10A and 10B, and so on until 4 of the 64 ports on each of the networking device 300 and the networking device 1000 are coupled to an eighth of the computing devices 200 in the GPU pod 1300 (e.g., the “bottom” computing device 200 in FIG. 13) similarly as described above with reference to FIGS. 10A and 10B.

As such, in this specific example, 32 ports on each of the networking device 300 and the networking device 1000 may be coupled to the computing devices 200 in the GPU pod 1300, with the remaining 32 ports coupled to spine switch devices as described in further detail below. Furthermore, while 64-port networking devices providing 400G/port is described, one of skill in the art in possession of the present disclosure will appreciate how the teachings of the present disclosure may be applied to networking devices with 32 or fewer ports, as well as networking devices with 128, 256, 512 or more ports, and/or ports with different speeds, while remaining within the scope of the present disclosure as well.

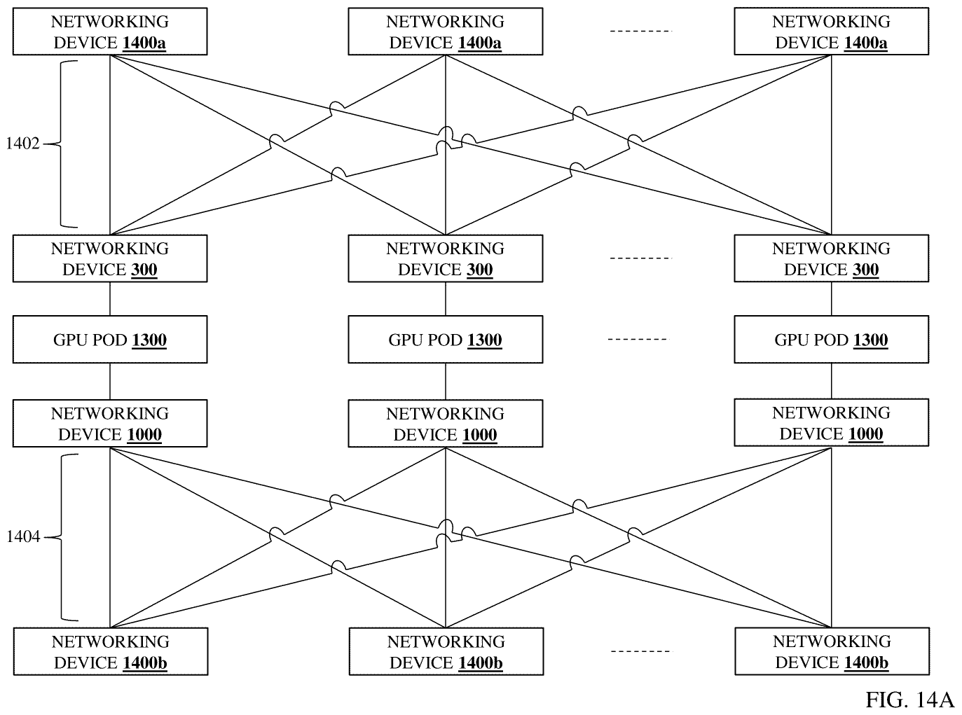

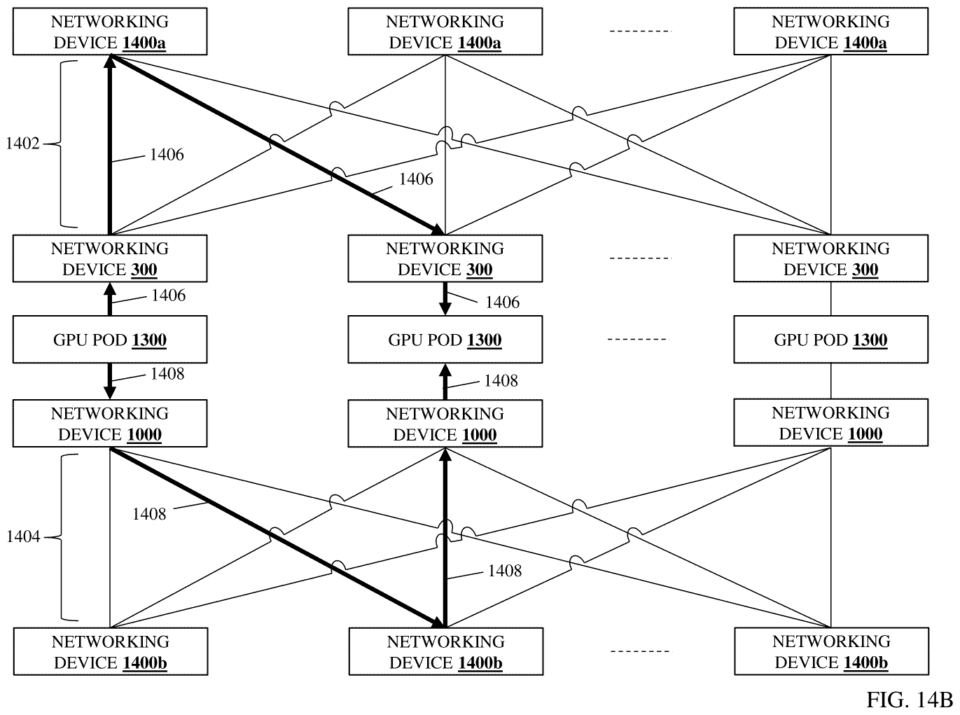

With reference to FIG. 14A, the Ethernet AI fabric configuration of the present disclosure utilizing the “odd/even” internal switch fabric scaling described above may include 32 “odd” fabric networking devices 1400a (configured as the “spine switch devices” discussed above) that each include 64 ports, and thus may each couple to 64 of the networking devices 300 that are each coupled to one of the GPU pods 1300 discussed above to provide an “odd” fabric 1402. Furthermore, the Ethernet AI fabric configuration of the present disclosure utilizing the “odd/even” internal switch fabric scaling described above may also include 32 “even” fabric networking devices 1400b (configured as the “spine switch devices” discussed above) that each include 64 ports, and thus may each couple to 64 of the networking devices 1000 that are each coupled to one of the GPU pods 1300 discussed above to provide an “even” fabric 1404. As illustrated in FIG. 14B, any GPU in any of the GPU pods 1300 may perform GPU communication operations 1406 to communicate with other GPUs via the “odd” fabric 1402 accessible via the networking devices 300 and 1400a, as well as GPU communication operations 1408 to communicate with other GPUs via the “even” fabric 1404 accessible via the networking devices 1000 and 1400b.

Furthermore, using the definition of the GPU pod 1300 discussed above, the Ethernet AI fabric of FIG. 14A allows for the coupling of up to (8 computing devices/GPU pod*64 GPU pods=) 512 computing devices, and up to (8 GPUs/computing device*512 computing devices=) 4096 GPUs. As such, the “odd/even” internal switch fabric scaling described above doubles the number of GPUs that may be provided in the Ethernet AI fabric using the same hardware as provided in the conventional Ethernet AI fabric discussed above with reference to FIGS. 5-9.

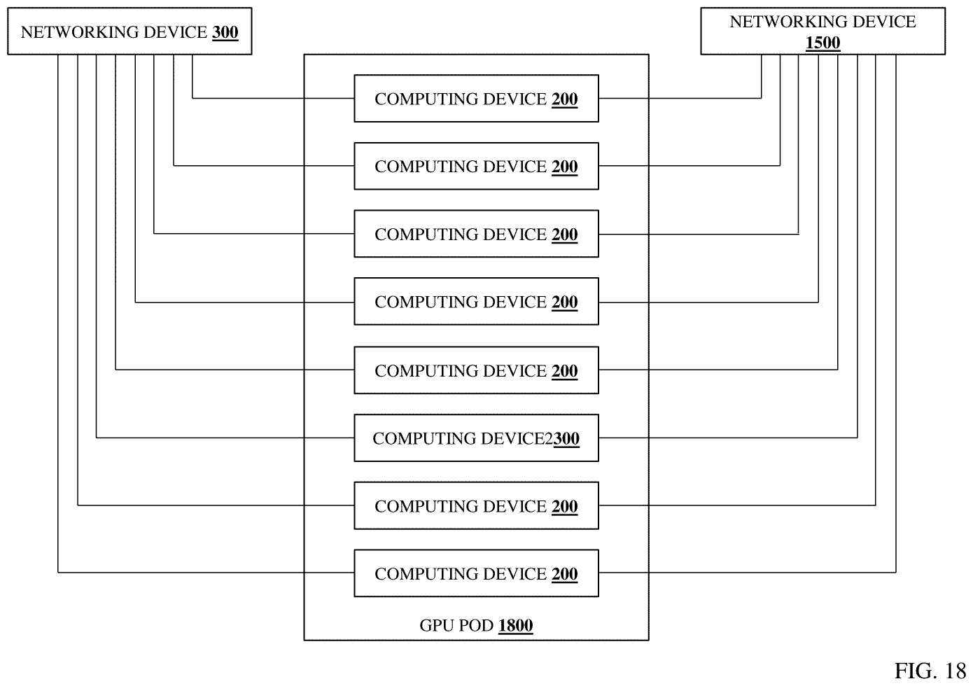

Returning to the example of the second implementation of the teachings of the present disclosure provided above, in an embodiment of block 406, GPUs in computing devices included in the Ethernet AI fabric configuration of the present disclosure that utilizes the “top/bottom” internal switch fabric scaling described above may communicate with each other. With reference to FIG. 18, a GPU “pod” 1800 may be defined in the Ethernet AI fabric configuration of FIGS. 15A and 15B, and may be provided by connecting eight of the computing devices 200 discussed above to each of the networking device 300 and the networking device 1500 discussed above (i.e., doubling the number of computing devices 200 that may be connected to a networking device to relative to the conventional GPU “pod” 800 discussed above with reference to FIG. 8).

For example, the networking devices 300 and 1500 of FIG. 18 may each include 64 ports, with 4 of the 64 ports on each of the networking device 300 and the networking device 1500 coupled to a first of the computing devices 200 in the GPU pod 1800 (e.g., the “top” computing device 200 in FIG. 18) similarly as described above with reference to FIGS. 15A and 15B, 4 of the 64 ports on each of the networking device 300 and the networking device 1500 coupled to a second of the computing devices 200 in the GPU pod 1800 (e.g., the “second from the top” computing device 200 in FIG. 18) similarly as described above with reference to FIGS. 15A and 15B, and so on until 4 of the 64 ports on each of the networking device 300 and the networking device 100 are coupled to an eighth of the computing devices 200 in the GPU pod 1800 (e.g., the “bottom” computing device 200 in FIG. 18) similarly as described above with reference to FIGS. 15A and 15B.

As such, in this specific example, 32 ports on each of the networking device 300 and the networking device 1500 may be coupled to the computing devices 200 in the GPU pod 1800, with the remaining 32 ports coupled to spine switch devices as described in further detail below. Furthermore, while a 64-port networking devices providing 400G/port is described, one of skill in the art in possession of the present disclosure will appreciate how the teachings of the present disclosure may be applied to networking devices with 32 or fewer ports, as well as networking devices with 128, 256, 512 or more ports, and/or ports with different speeds, while remaining within the scope of the present disclosure as well.

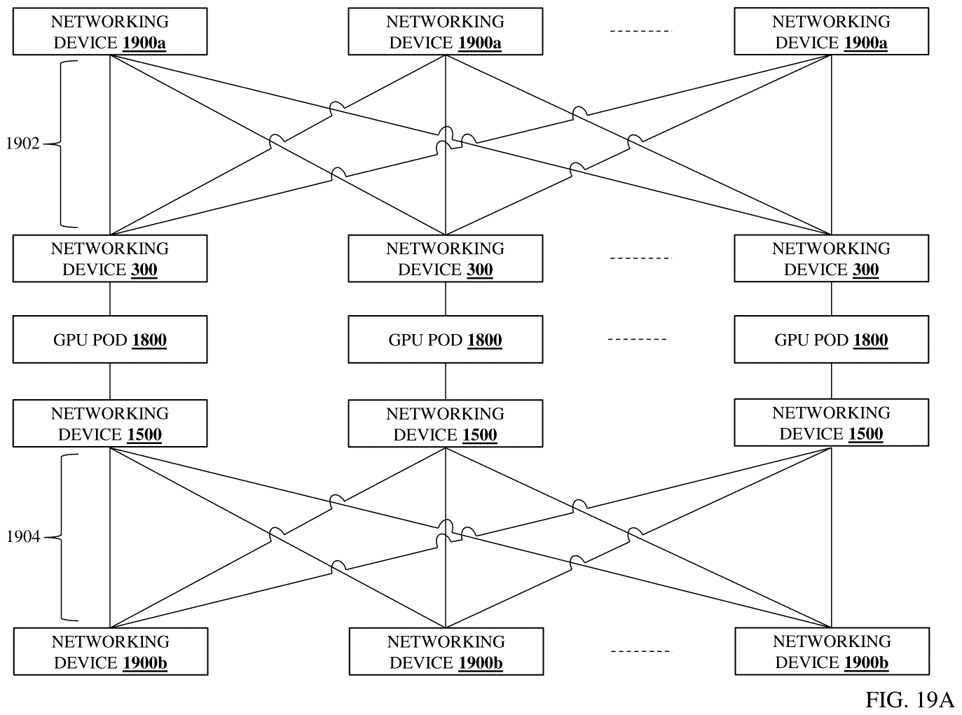

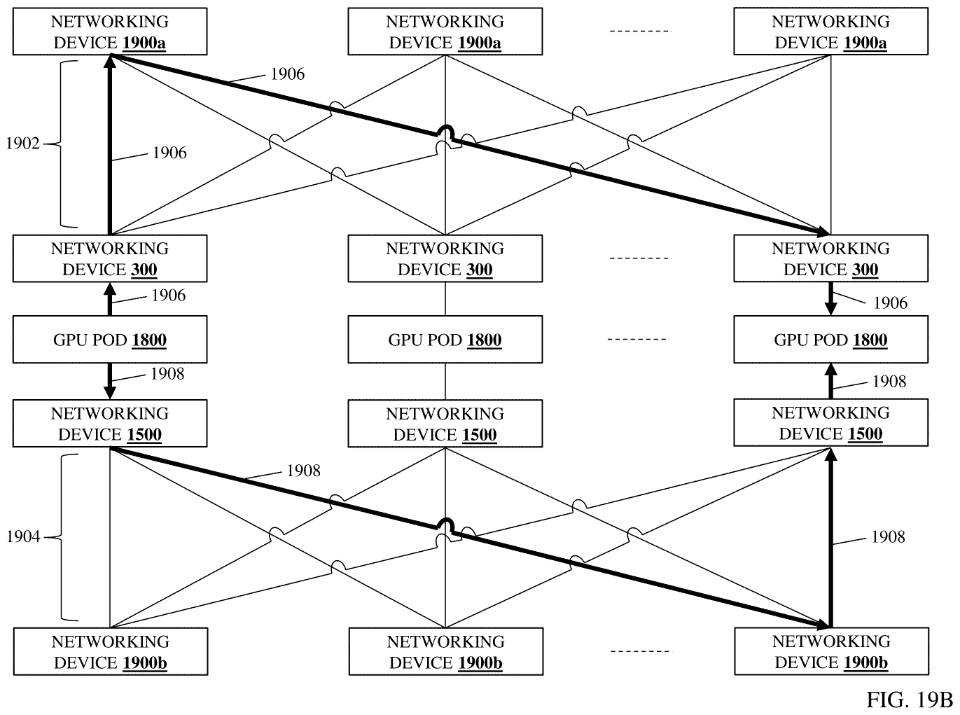

With reference to FIG. 19A, the Ethernet AI fabric configuration of the present disclosure utilizing the “top/bottom” internal switch fabric scaling described above may include 32 “top” fabric networking devices 1900a (configured as the “spine switch devices” discussed above) that each include 64 ports, and thus may each couple to 64 of the networking devices 300 that are each coupled to one of the GPU pods 1800 discussed above to provide a “top” fabric 1902. Furthermore, the Ethernet AI fabric configuration of the present disclosure utilizing the “top/bottom” internal switch fabric scaling described above may also include 32 “bottom” fabric networking devices 1900b (configured as the “spine switch devices” discussed above) that each include 64 ports, and thus may each couple to 64 of the networking devices 1500 that are each coupled to one of the GPU pods 1800 discussed above to provide a “bottom” fabric 1904. As illustrated in FIG. 19B, any GPU in any of the GPU pods 1800 may perform GPU communication operations 1906 to communicate with other GPUs via the “top” fabric 1902 accessible via the networking devices 300 and 1900a, as well as GPU communication operations 1908 to communicate with other GPUs via the “bottom” fabric 1904 accessible via the networking devices 1500 and 1900b.

Furthermore, using the definition of the GPU pod 1800 discussed above, the Ethernet AI fabric of FIG. 19A allows for the coupling of up to (8 computing devices/GPU pod*64 GPU pods=) 512 computing devices, and up to (8 GPUs/computing device*512 computing devices=) 4096 GPUs. As such, the “top/bottom” internal switch fabric scaling described above doubles the number of GPUs that may be provided in the Ethernet AI fabric using the same hardware as provided in the conventional Ethernet AI fabric discussed above with reference to FIGS. 5-9.

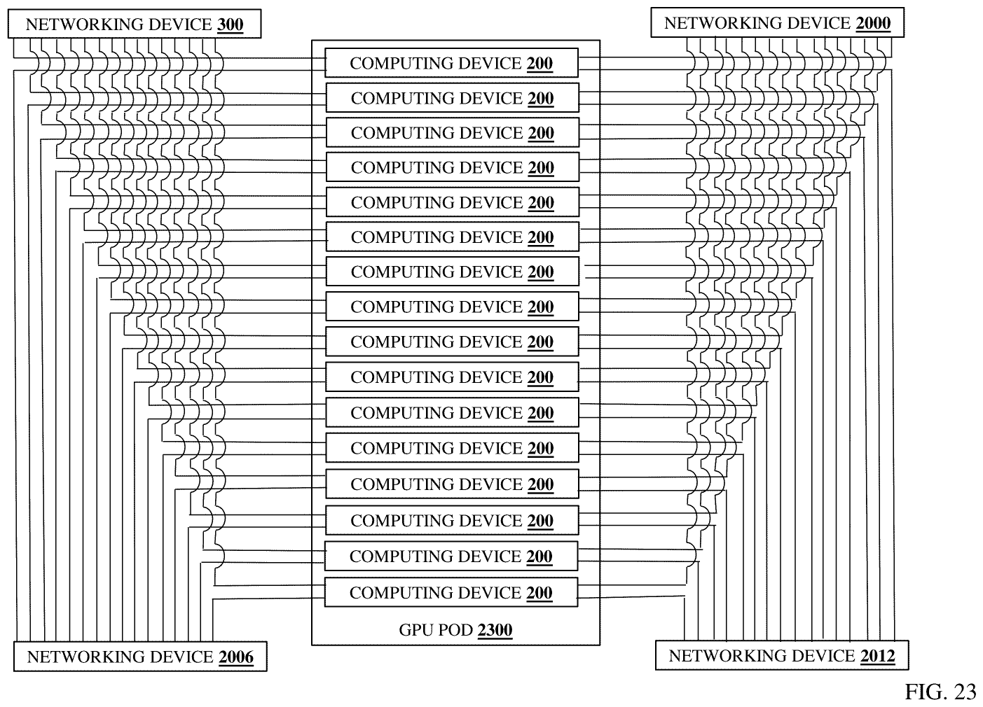

Returning to the example of the third implementation of the teachings of the present disclosure provided above, in an embodiment of block 406, GPUs in computing devices included in the Ethernet AI fabric configuration of the present disclosure that utilizes the “top/odd”, “top/even”, “bottom/odd”, “bottom/even” internal switch fabric scaling described above may communicate with each other. With reference to FIG. 23, a GPU “pod” 2300 may be defined in the Ethernet AI fabric configuration of FIGS. 20A, 20B, 20C, and 20D, and may be provided by connecting sixteen of the computing devices 200 discussed above to each of the networking device 300, the networking device 2000, the networking device 2006, and the networking device 2012 discussed above (i.e., quadrupling the number of computing devices 200 that may be connected to a networking device to relative to the conventional GPU “pod” 800 discussed above with reference to FIG. 8).

For example, the networking devices 300, 2000, 2006, and 2012 of FIG. 23 may each include 64 ports, with 2 of the 64 ports on each of the networking devices 300, 2000, 2006, and 2012 coupled to a first of the computing devices 200 in the GPU pod 2300 (e.g., the “top” computing device 200 in FIG. 23) similarly as described above with reference to FIGS. 20A-20D, 2 of the 64 ports on each of the networking devices 300, 2000, 2006, and 2012 coupled to a second of the computing devices 200 in the GPU pod 2300 (e.g., the “second from the top” computing device 200 in FIG. 23) similarly as described above with reference to FIGS. 20A-20D, and so on until 2 of the 64 ports on each of the networking devices 300, 2000, 2006, and 2012 are coupled to an eighth of the computing devices 200 in the GPU pod 2300 (e.g., the “bottom” computing device 200 in FIG. 23) similarly as described above with reference to FIGS. 20A-20D.

As such, in this specific example, 32 ports on each of the devices 300, 2000, 2006, and 2012 may be coupled to the computing devices 200 in the GPU pod 2300, with the remaining 32 ports coupled to spine switch devices as described in further detail below. Furthermore, while a 64-port networking devices providing 400G/port is described, one of skill in the art in possession of the present disclosure will appreciate how the teachings of the present disclosure may be applied to networking devices with 32 or fewer ports, as well as networking devices with 128, 256, 512 or more ports, and/or ports with different speeds, while remaining within the scope of the present disclosure as well.

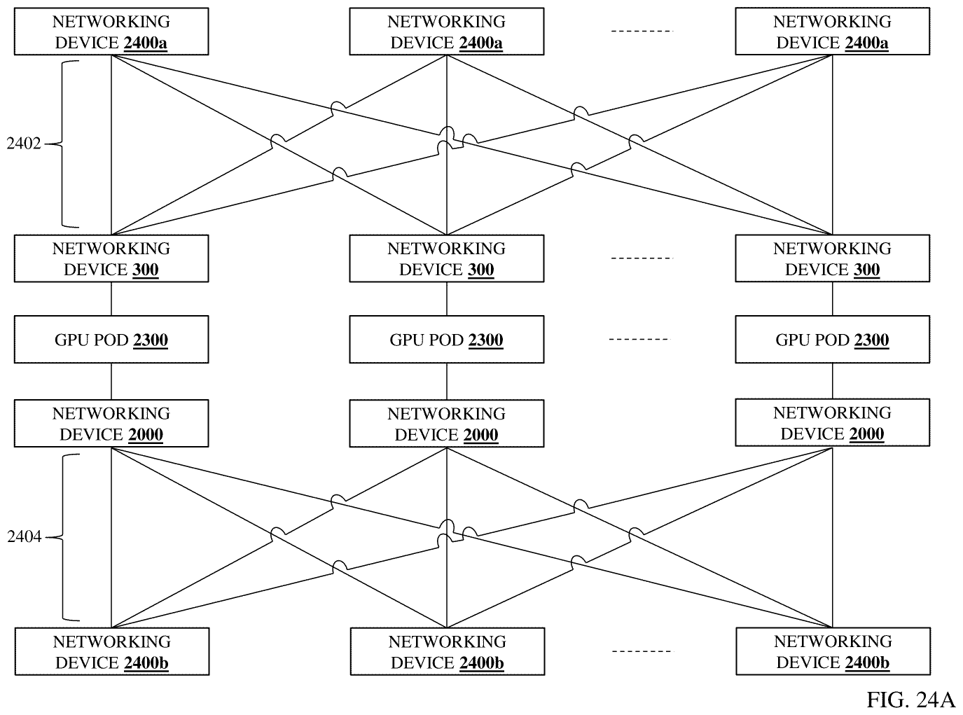

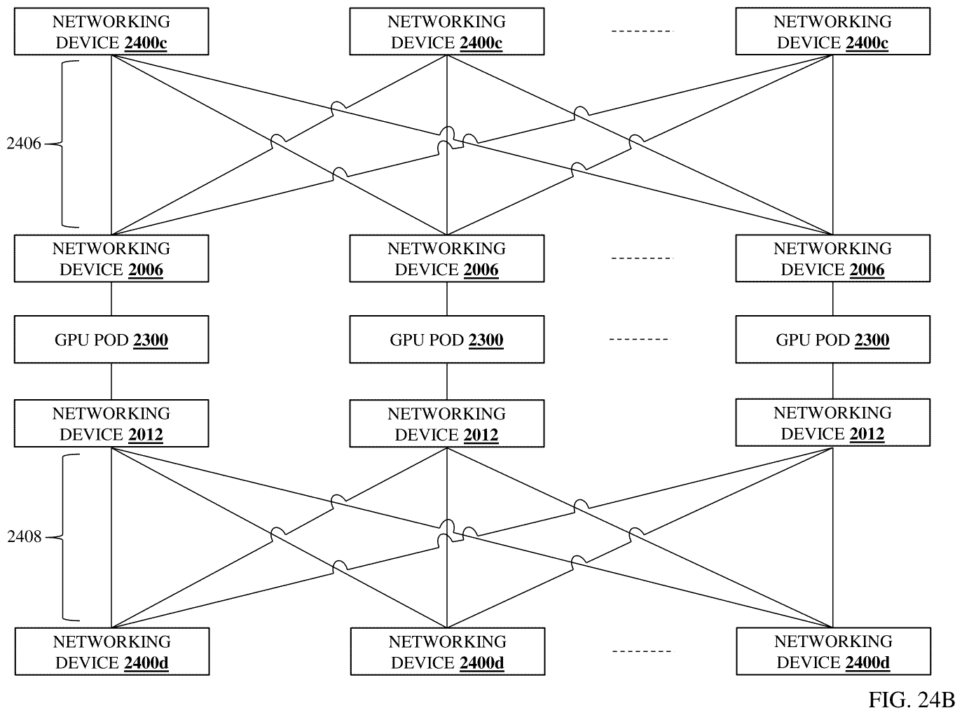

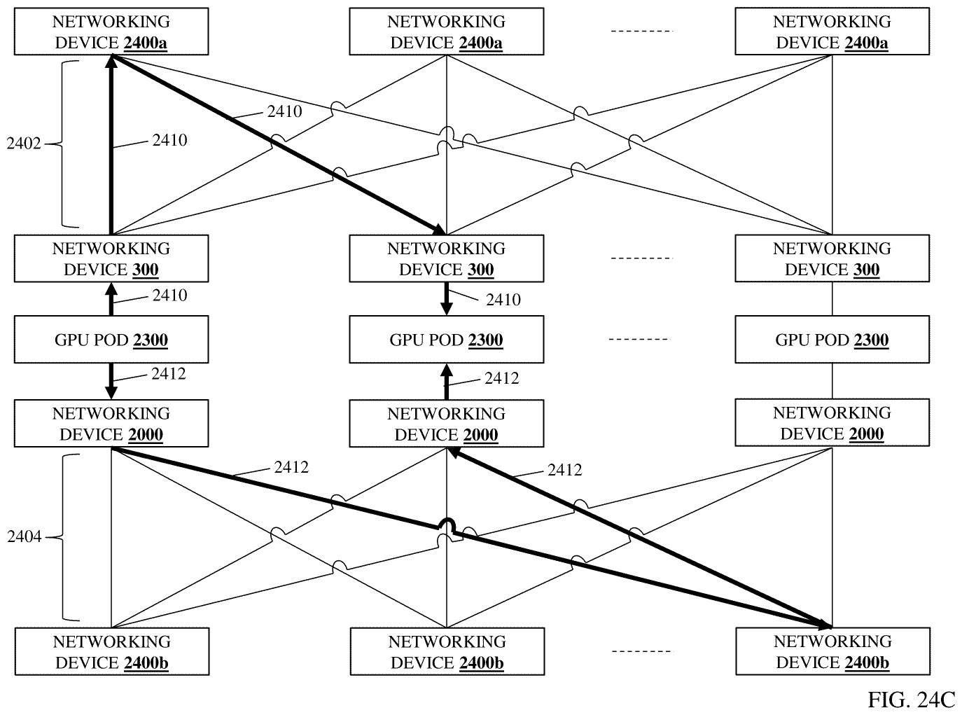

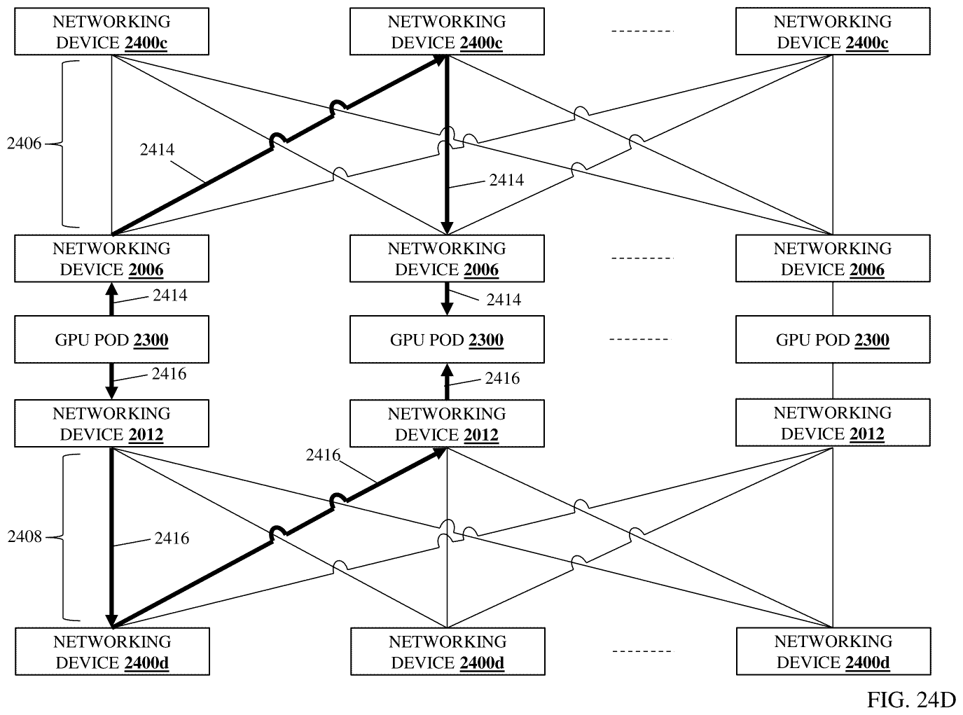

With reference to FIGS. 24A and 24B, the Ethernet AI fabric configuration of the present disclosure utilizing the “top/odd”, “top/even”, “bottom/odd”, “bottom/even” internal switch fabric scaling described above may include 32 “top/even” fabric networking devices 2400a (configured as the “spine switch devices” discussed above) that each include 64 ports, and thus may each couple to 64 of the networking devices 300 that are each coupled to one of the GPU pods 2300 discussed above to provide a “top/odd” fabric 2402. Furthermore, the Ethernet AI fabric configuration of the present disclosure utilizing the “top/odd”, “top/even”, “bottom/odd”, “bottom/even” internal switch fabric scaling described above may also include 32 “top/even” fabric networking devices 2400b (configured as the “spine switch devices” discussed above) that each include 64 ports, and thus may each couple to 64 of the networking devices 2000 that are each coupled to one of the GPU pods 2300 discussed above to provide a “top/even” fabric 2404.

Further still, the Ethernet AI fabric configuration of the present disclosure utilizing the “top/odd”, “top/even”, “bottom/odd”, “bottom/even” internal switch fabric scaling described above may also include 32 “bottom/odd” fabric networking devices 2400c (configured as the “spine switch devices” discussed above) that each include 64 ports, and thus may each couple to 64 of the networking devices 2006 that are each coupled to one of the GPU pods 2300 discussed above to provide a “bottom/odd” fabric 2406. Yet further still, the Ethernet AI fabric configuration of the present disclosure utilizing the “top/odd”, “top/even”, “bottom/odd”, “bottom/even” internal switch fabric scaling described above may also include 32 “bottom/even” fabric networking devices 2400d (configured as the “spine switch devices” discussed above) that each include 64 ports, and thus may each couple to 64 of the networking devices 2012 that are each coupled to one of the GPU pods 2300 discussed above to provide a “bottom/even” fabric 2408.

As illustrated in FIGS. 24C and 24D, any GPU in any of the GPU pods 2300 may perform GPU communication operations 2410 to communicate with other GPUs via the “top/odd” fabric 2402 accessible via the networking devices 300 and 2400a, as well as GPU communication operations 2412 to communicate with other GPUs via the “top/even” fabric 2404 accessible via the networking devices 2000 and 2400b, GPU communication operations 2414 to communicate with other GPUs via the “bottom/odd” fabric 2406 accessible via the networking devices 2006 and 2400c, and GPU communication operations 2416 to communicate with other GPUs via the “bottom/even” fabric 2408 accessible via the networking devices 2012 and 2400d.

Furthermore, using the definition of the GPU pod 2300 discussed above, the Ethernet AI fabric of FIGS. 24A and 24B allows for the coupling of up to (16 computing devices/GPU pod*64 GPU pods=) 1024 computing devices, and up to (8 GPUs/computing device*1024 computing devices=) 8192 GPUs. As such, the “top/odd”, “top/even”, “bottom/odd”, “bottom/even” internal switch fabric scaling described above quadruples the number of GPUs that may be provided in the Ethernet AI fabric using the same hardware as provided in the conventional Ethernet AI fabric discussed above with reference to FIGS. 5-9.

As discussed above, while three specific examples are provided above, modifications to the Ethernet AI fabric configurations in those examples will fall within the scope of the present disclosure as well. For example, the Ethernet AI fabric configuration of the present disclosure utilizing the “top/odd”, “top/even”, “bottom/odd”, “bottom/even” internal switch fabric scaling described above may be modified to prevent potential conflicts that may result from the sharing of 200G MACs by pairs of GPUs (as illustrated and described above with reference to FIGS. 21 and 22).

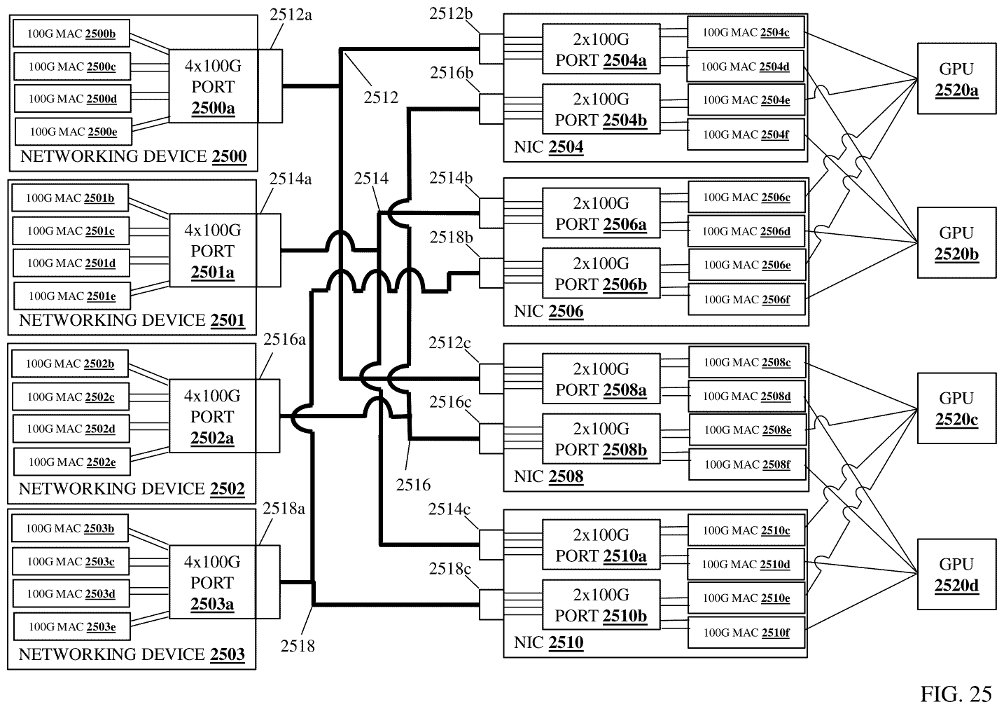

With reference to FIG. 25, a specific example of the networking device/NIC/GPU connections in the Ethernet AI fabric configuration of FIGS. 20A, 20B, 20C, and 20D is illustrated that operates to prevent the potential conflicts resulting from the sharing of 200G MACs by pairs of GPUs discussed above. In the illustrated embodiment, a networking device 2500 is illustrated connected to NICs in a computing device, a networking device 2501 is illustrated connected to NICs in that computing device, a networking device 2502 is illustrated connected to NICs in that computing device, a networking device 2103 is illustrated connected to NICs in that computing device, and one of skill in the art in possession of the present disclosure will appreciate how FIG. 25 may illustrate the connection of the networking device 300 (provided by the networking device 2500) to the NICs 204a and 204c on the computing device 200 illustrated in FIG. 20A, the connection of the networking device 2000 (provided by the networking device 2501) to the NICs 204b and 204d on the computing device 200 illustrated in FIG. 20B, the connection of the networking device 2006 (provided by the networking device 2502) to the NICs 204a and 204c on the computing device 200 illustrated in FIG. 20C, and the connection of the networking device 2012 (provided by the networking device 2503) to the NICs 204b and 204d on the computing device 200 illustrated in FIG. 20D.

Furthermore, one of skill in the art in possession of the present disclosure will also appreciate how FIG. 25 may also illustrate the connection of the networking device 300 (provided by the networking device 2500) to the NICs 204e and 204g on the computing device 200 illustrated in FIG. 20A, the connection of the networking device 2000 (provided by the networking device 2501) to the NICs 204f and 204h on the computing device 200 illustrated in FIG. 20B, the connection of the networking device 2006 (provided by the networking device 2502) to the NICs 204e and 204g on the computing device 200 illustrated in FIG. 20C, and the connection of the networking device 2012 (provided by the networking device 2503) to the NICs 204f and 204h on the computing device 200 illustrated in FIG. 20D.

As illustrated, the networking device 2500 may include a 4×100G port 2500a that may provide the port 304a (or the port 304e) on the networking device 300 of FIG. 20A, the networking device 2501 may include a 4×00G port 2501a that may provide the port 2004b (or the port 2004f) on the networking device 2000 of FIG. 20B, the networking device 2502 may include a 4×100G port 2502a that may provide the port 2010a (or the port 2010e) on the networking device 2006 of FIG. 20C, and the networking device 2503 may include a 4×100G port 2503a that may provide the port 2016b (or the port 2016f) on the networking device 2012 of FIG. 20D. As will be appreciated by one of skill in the art in possession of the present disclosure, the networking device 2500 may include four 100G MACs 2500b, 2500c, 2500d, and 2500e each providing two 50G lanes to the 4×100G port 2500a (as illustrated by the two lines between each of the 100G MACs 2500b, 2500c, 2500d, and 2500e and the 4×100 port 2500a, in FIG. 25).

Similarly, the networking device 2501 may include four 100G MACs 2501b, 2501c, 2501d, and 2501e each providing two 50G lanes to the 4×100G port 2501a (as illustrated by the two lines between each of the 100G MACs 2501b, 2501c, 2501d, and 2501e and the 4×100 port 2501a, in FIG. 25). Similarly as well, the networking device 2502 may include four 100G MACs 2502b, 2502c, 2502d, and 2502e each providing two 50G lanes to the 4×100G port 2502a (as illustrated by the two lines between each of the 100G MACs 2502b, 2502c, 2502d, and 2502e and the 4×100 port 2502a, in FIG. 25). Similarly as well, the networking device 2503 may include four 100G MACs 2503b, 2503c, 2503d, and 2503e each providing two 50G lanes to the 4×100G port 2503a (as illustrated by the two lines between each of the 100G MACs 2503b, 2503c, 2503d, and 2503e and the 4×100 port 2503a, in FIG. 25).

A computing device (not illustrated) that may provide the computing device 200 of FIGS. 20A, 20B, 20C, and 20D includes NICs 2504, 2506, 208, and 2510 that may provide the NICs 204a, 204b, 204c, and 204d (or the NICs 204e, 204f, 204g, and 204h) of FIGS. 20A, 20B, 20C, and 20D. In the illustrated embodiment, the NIC 2504 includes a pair of 2×100G ports 2504a and 2504b that are each coupled to a respective pair of 100G MACs 2504c/2504d and 2504e/2504f, the NIC 2506 includes a pair of 2×100G ports 2506a and 2506b that are each coupled to a respective pair of 100G MACs 2506c/2506d and 2506e/2506f, the NIC 2108 includes a pair of 2×100G ports 2508a and 2508b that are each coupled to a respective pair of 100G MACs 2508c/2508d and 2508e/2508f, and the NIC 2110 includes a pair of 2×100G ports 2510a and 2510b that are each coupled to a respective pair of 100G MACs 2510c/2510d and 2510e/2510f. A plurality of breakout cables 2512, 2514, 2516, and 2518 couple the 4×100G ports 2500a, 2501a, 2502a, and 2503a, respectively, to the NICs 2504/2508, 2506/2510, 2508, and 2506/2510, respectively, and may provide the breakout cables 2000a, 2000c, 2000e and 2000g (or the breakout cables 2000b, 2000d, 2000f, and 2000h) of FIGS. 20A, 20B, 20C, and 20D.

As can be seen, the breakout cable 2512 includes a first connector 2512a connected to the 4×100G port 2500a, a second connector 2512b connected to the 2×100G port 2504a to couple the four 50G lanes (provided by the 100G MACs 2500b and 2500c to the 4×100G port 2500a) from the 4×100G port 2500a to the 2×100G port 2504a (as illustrated by the four lines between the second connector 2512b and the 2×100G port 2504a in FIG. 25), and a second connector 2512c connected to the 2×100G port 2508a to couple the four 50G lanes (provided by the 100G MACs 2500d and 2500e to the 4×100G port 2500a) from the 4×100G port 2500a to the 2×100G port 2508a (as illustrated by the four lines between the second connector 2512c and the 2×100G port 2508a in FIG. 25), with two 50G lanes provided between the 2×100G port 2504a and the 100G MAC 2504c (as illustrated by the two lines between the 2×100G port 2504a and the 100G MAC 2504c in FIG. 25), two 50G lanes provided between the 2×100G port 2504a and the 100G MAC 2504d (as illustrated by the two lines between the 2×100G port 2504a and the 100G MAC 2504d in FIG. 25), two 50G lanes provided between the 2×100G port 2508a and the 100G MAC 2508c (as illustrated by the two lines between the 2×100G port 2508a and the 100G MAC 2508c in FIG. 25), and two 50G lanes provided between the 2×100G port 2508a and the 100G MAC 2508d (as illustrated by the two lines between the 2×100G port 2508a and the 100G MAC 2508d in FIG. 25).

Similarly, the breakout cable 2514 includes a first connector 2514a connected to the 4×100G port 2501a, a second connector 2514b connected to the 2×100G port 2506a to couple the four 50G lanes (provided by the 100G MACs 2501b and 2501c to the 4×100G port 2501a) from the 4×100G port 2501a to the 2×100G port 2506a (as illustrated by the four lines between the second connector 2514b and the 2×100G port 2506a in FIG. 25), and a second connector 2514c connected to the 2×100G port 2510a to couple the four 50G lanes (provided by the 100G MACs 2501d and 2501e to the 4×100G port 2501a) from the 4×100G port 2501a to the 2×100G port 2510a (as illustrated by the four lines between the second connector 2514c and the 2×100G port 2510a in FIG. 25), with two 50G lanes provided between the 2×100G port 2506a and the 100G MAC 2506c (as illustrated by the two lines between the 2×100G port 2506a and the 100G MAC 2506c in FIG. 25), two 50G lanes provided between the 2×100G port 2506a and the 100G MAC 2506d (as illustrated by the two lines between the 2×100G port 2506a and the 100G MAC 2506d in FIG. 25), two 50G lanes provided between the 2×100G port 2510a and the 100G MAC 2510c (as illustrated by the two lines between the 2×100G port 2510a and the 100G MAC 2510c in FIG. 25), and two 50G lanes provided between the 2×100G port 2510a and the 100G MAC 2510d (as illustrated by the two lines between the 2×100G port 2510a and the 100G MAC 2510d in FIG. 25).

Similarly as well, the breakout cable 2516 includes a first connector 2516a connected to the 4×100G port 2502a, a second connector 2516b connected to the 2×100G port 2504b to couple the four 50G lanes (provided by the 100G MACs 2502b and 2502c to the 4×100G port 2502a) from the 4×100G port 2502a to the 2×100G port 2504b (as illustrated by the four lines between the second connector 2516b and the 2×100G port 2504b in FIG. 25), and a second connector 2516c connected to the 2×100G port 2508b to couple the four 50G lanes (provided by the 100G MACs 2502d and 2502e to the 4×100G port 2502a) from the 4×100G port 2502a to the 2×100G port 2508b (as illustrated by the four lines between the second connector 2516c and the 2×100G port 2508b in FIG. 25), with two 50G lanes provided between the 2×100G port 2504b and the 100G MAC 2504e (as illustrated by the two lines between the 2×100G port 2504b and the 100G MAC 2504e in FIG. 25), two 50G lanes provided between the 2×100G port 2504b and the 100G MAC 2504f (as illustrated by the two lines between the 2×100G port 2504b and the 100G MAC 2504f in FIG. 25), two 50G lanes provided between the 2×100G port 2508b and the 100G MAC 2508e (as illustrated by the two lines between the 2×100G port 2508b and the 100G MAC 2508e in FIG. 25), and two 50G lanes provided between the 2×100G port 2508b and the 100G MAC 2508f (as illustrated by the two lines between the 2×100G port 2508b and the 100G MAC 2508f in FIG. 25).

Similarly as well, the breakout cable 2518 includes a first connector 2518a connected to the 4×100G port 2503a, a second connector 2518b connected to the 2×100G port 2506b to couple the four 50G lanes (provided by the 100G MACs 2503b and 2503c to the 4×100G port 2503a) from the 4×100G port 2503a to the 2×100G port 2506b (as illustrated by the four lines between the second connector 2518b and the 2×100G port 2506b in FIG. 25), and a second connector 2518c connected to the 2×100G port 2510b to couple the four 50G lanes (provided by the 100G MACs 2503d and 2503e to the 4×100G port 2503a) from the 4×100G port 2503a to the 2×100G port 2510b (as illustrated by the four lines between the second connector 2518c and the 2×100G port 2510b in FIG. 25), with two 50G lanes provided between the 2×100G port 2506b and the 100G MAC 2506e (as illustrated by the two lines between the 2×100G port 2506b and the 100G MAC 2506e in FIG. 25), two 50G lanes provided between the 2×100G port 2506b and the 100G MAC 2506f (as illustrated by the two lines between the 2×100G port 2506b and the 100G MAC 2506f in FIG. 25), two 50G lanes provided between the 2×100G port 2510b and the 100G MAC 2510e (as illustrated by the two lines between the 2×100G port 2510b and the 100G MAC 2510e in FIG. 25), and two 50G lanes provided between the 2×100G port 2510b and the 100G MAC 2510f (as illustrated by the two lines between the 2×100G port 2510b and the 100G MAC 2510f in FIG. 25).

With continued reference to FIG. 25, the internal switch fabric (not illustrated, but which may provide the internal switch fabric 208 of FIGS. 20A, 20B, 20C, and 20D) is configured with a 1-to-4 GPU-to-NIC mapping between a GPU 2520a that may provide the GPU 206a (or the GPU 206e) of FIGS. 20A, 20B, 20C, and 20D, and the 100G MAC 2504c and the 100G MAC 2504e in the NIC 2504, as well as the 100G MAC 2506c and the 100G MAC 2506e in the NIC 2506. Similarly, the internal switch fabric (not illustrated, but which may provide the internal switch fabric 208 of FIGS. 20A, 20B, 20C, and 20D) is configured with a 1-to-4 GPU-to-NIC mapping between a GPU 2520b that may provide the GPU 206b (or the GPU 206f) of FIGS. 20A, 20B, 20C, and 20D, and each of the 100G MAC 2504d and the 100G MAC 2504f in the NIC 2504, as well as the 100G MAC 2506d and the 100G MAC 2506f in the NIC 2506. As such, one of skill in the art in possession of the present disclosure will appreciate how each of the GPUs 2520a and 2520b is provided with an aggregated 400G connectivity to the fabrics accessible via each of the networking devices 2500, 2501, 2502, and 2503 (e.g., the “top/odd” fabric accessible via the networking device 300/2500, the “top/even” fabric accessible via the networking device 2000/2501, the “bottom/odd” fabric accessible via the networking device 2006/2502, and the “bottom/even” fabric accessible via the networking device 2112/2503) via four parallel, unshared 100G paths.

With continued reference to FIG. 25, the internal switch fabric (not illustrated, but which may provide the internal switch fabric 208 of FIGS. 20A, 20B, 20C, and 20D) is configured with a 1-to-4 GPU-to-NIC mapping between a GPU 2520c that may provide the GPU 206c (or the GPU 206g) of FIGS. 20A, 20B, 20C, and 20D, and each of the 100G MAC 2508c and the 100G MAC 2508e in the NIC 2508, as well as the 100G MAC 2510c and the 100G MAC 2510e in the NIC 2510. Similarly, the internal switch fabric (not illustrated, but which may provide the internal switch fabric 208 of FIGS. 20A, 20B, 20C, and 20D) is configured with a 1-to-4 GPU-to-NIC mapping between a GPU 2520d that may provide the GPU 206d (or the GPU 206h) of FIGS. 20A, 20B, 20C, and 20D, and each of the 100G MAC 2508d and the 100G MAC 2508f in the NIC 2508, as well as the 100G MAC 2510d and the 100G MAC 2510f in the NIC 2510. As such, one of skill in the art in possession of the present disclosure will appreciate how each of the GPUs 2520c and 2520d is provided with an aggregated 400G connectivity to the fabrics accessible via each of the networking devices 2500, 2501, 2502, and 2503 (e.g., the “top/odd” fabric accessible via the networking device 300/2500, the “top/even” fabric accessible via the networking device 2000/2501, the “bottom/odd” fabric accessible via the networking device 2006/2502, and the “bottom/even” fabric accessible via the networking device 2112/2503) via four parallel, unshared 100G paths.

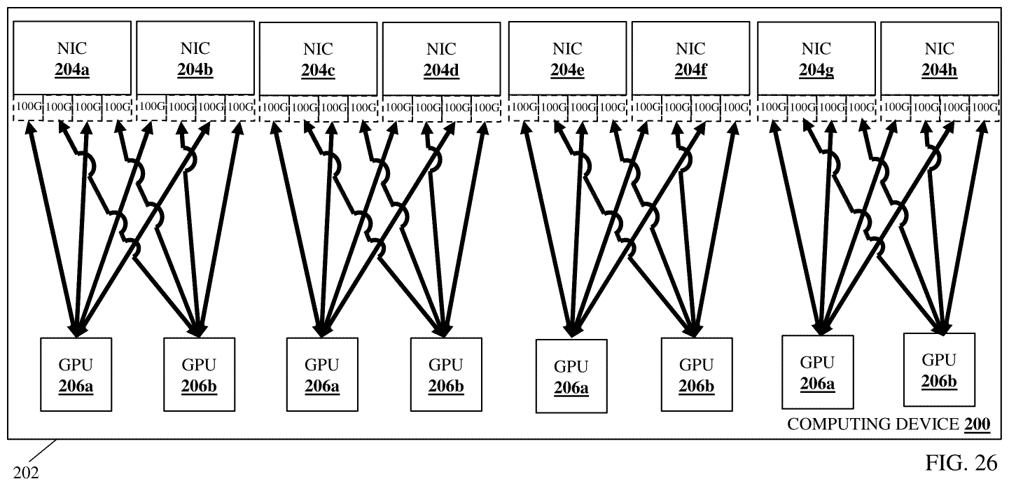

With reference to FIG. 26, the 1-to-4 GPU-to-NIC mappings provided by the internal switch fabric 208 (not illustrated in FIG. 26 for clarity) between the GPUs 206a-206h and the NICs 204a-204h, respectively, in the Ethernet AI fabric configuration of FIGS. 20A, 20B, 20C, and 20D is illustrated, with a 1-to-4 GPU-to-NIC mapping provided by the switch device 208a enabling parallel, unshared 100G paths between the GPU 206a and the NIC set provided by the NICs 204a and 204b to provide the GPU 206a with 400G connectivity, a 1-to-4 GPU-to-NIC mapping provided by the switch device 208a enabling parallel, unshared 100G paths between the GPU 206b and the NIC set provided by the NICs 204a and 204b to provide the GPU 206b with 400G connectivity, a 1-to-4 GPU-to-NIC mapping provided by the switch device 208b enabling parallel, unshared 100G paths between the GPU 206c and the NIC set provided by the NICs 204c and 204d to provide the GPU 206c with 400G connectivity, a 1-to-4 GPU-to-NIC mapping provided by the switch device 208b enabling parallel, unshared 100G paths between the GPU 206d and the NIC set provided by the NICs 204c and 204d to provide the GPU 206d with 400G connectivity, a 1-to-4 GPU-to-NIC mapping provided by the switch device 208c enabling parallel, unshared 100G paths between the GPU 206e and the NIC set provided by the NICs 204e and 204f to provide the GPU 206e with 400G connectivity, a 1-to-4 GPU-to-NIC mapping provided by the switch device 208c enabling parallel, unshared 100G paths between the GPU 206f and the NIC set provided by the NICs 204e and 204f to provide the GPU 206f with 400G connectivity, a 1-to-4 GPU-to-NIC mapping provided by the switch device 208d enabling parallel, unshared 100G paths between the GPU 206g and the NIC set provided by the NICs 204g and 204h to provide the GPU 206g with 400G connectivity, and a 1-to-4 GPU-to-NIC mapping provided by the switch device 208d enabling parallel, unshared 100G paths between the GPU 206h and the NIC set provided by the NICs 204g and 204h to provide the GPU 206h with 400G connectivity. However, while a specific 1-to-4 GPU-to-NIC mapping is illustrated, mappings with more (or fewer) GPUs to NICs, or a single GPU to multiple NICs, will fall within the scope of the present disclosure as well.

Thus, one of skill in the art in possession of the present disclosure will appreciate how Ethernet AI fabric configurations with internal switch fabric configurations like those illustrated and described in FIGS. 25 and 26 may be provided to prevent potential conflicts resulting from the sharing of MACs by pairs of GPUs. Furthermore, one of skill in the art in possession of the present disclosure how the Ethernet AI fabric configurations using the “top/odd”, “top/even”, “bottom/odd”, “bottom/even” internal switch fabric scaling described above may be utilized to provide smaller Ethernet AI fabrics via use of only a subset of the four available fabrics described above. For example, using two of the four available fabrics allows 32 of the GPU “pods” 2300 described above to provide 512 computing devices having 4096 GPUs in that Ethernet AI fabric. Similarly, using one of the four available fabrics allows 16 of the GPU “pods” 2300 described above to provide 256 computing devices having 2048 GPUs in that Ethernet AI fabric. As such, a wide variety of modification to the teachings provided above is envisioned as falling within the scope of the present disclosure.

Thus, systems and methods have been described that provide internal parallelism for GPUs in a computing device via an internal switch fabric in that computing device that connects each of those GPUs to parallel external fabrics that are accessible via a plurality of NICs in that computing device. For example, the internal GPU/NIC parallel switch fabric system of the present disclosure may include a computing device that is coupled to the plurality of external fabrics. The computing device includes at least one NIC that provides access to each of the plurality of external fabrics, and a plurality of GPUs. The computing device also includes an internal switch fabric that is configured to couple each of the plurality of GPUs to the at least one NIC to provide each of the plurality of GPUs access to each of the plurality of external fabrics. As such, Ethernet AI fabrics may be scaled to include greater numbers of GPUs that is available via conventional Ethernet AI fabric configurations.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. An internal Graphics Processing Unit (GPU)/Network Interface Controller (NIC) parallel switch fabric system, comprising:
a plurality of external fabrics; and
a computing device that is coupled to the plurality of external fabrics and that includes:
a Network Interface Controller (NIC) set that provides access to each of the plurality of external fabrics;
a plurality of Graphics Processing Units (GPUs); and
an internal switch fabric that is configured to couple each of the plurality of GPUs to the NIC set to provide each of the plurality of GPUs access to each of the plurality of external fabrics.

2. The system of claim 1, wherein the NIC set includes a first NIC that provides access to a first external fabric included in the plurality of external fabrics, and a second NIC that provides access to a second external fabric included in the plurality of external fabrics, and wherein the internal switch fabric is configured to:
couple a first GPU included in the plurality of GPUs to each of the first NIC and the second NIC to provide the first GPU access to each of the first external fabric and the second external fabric; and
couple a second GPU included in the plurality of GPUs to each of the first NIC and the second NIC to provide the second GPU access to each of the first external fabric and the second external fabric.

3. The system of claim 1, wherein the NIC set includes a first NIC that provides access to both a first external fabric and a second external fabric included in the plurality of external fabrics, and wherein the internal switch fabric is configured to:
couple a first GPU included in the plurality of GPUs to the first NIC to provide the first GPU access to each of the first external fabric and the second external fabric.

4. The system of claim 1, wherein the NIC set includes a first NIC and a second NIC that each provide access to both a first external fabric and a second external fabric included in the plurality of external fabrics, and wherein the internal switch fabric is configured to:
couple a first GPU included in the plurality of GPUs to the first NIC to provide the first GPU access to each of the first external fabric and the second external fabric; and
couple a second GPU included in the plurality of GPUs to the second NIC to provide the second GPU access to each of the first external fabric and the second external fabric.

5. The system of claim 1, wherein the NIC set includes a first NIC that provides access to both a first external fabric and a second external fabric included in the plurality of external fabrics, and a second NIC that provides access to both a third external fabric and a fourth external fabric included in the plurality of external fabrics, and wherein the internal switch fabric is configured to:
couple a first GPU included in the plurality of GPUs to each of the first NIC and the second NIC to provide the first GPU access to each of the first external fabric, the second external fabric, the third external fabric, and the fourth external fabric; and
couple a second GPU included in the plurality of GPUs to each of the first NIC and the second NIC to provide the second GPU access to each of the first external fabric, the second external fabric, the third external fabric, and the fourth external fabric.

6. The system of claim 5, wherein the first NIC includes a first NIC bandwidth that has been subdivided into a plurality of first NIC bandwidth subsets that are each shared by the first GPU and the second GPU, and wherein the second NIC includes a second NIC bandwidth that has been subdivided into a plurality of second NIC bandwidth subsets that are each shared by the first GPU and the second GPU.

7. The system of claim 5, wherein the first NIC includes a first NIC bandwidth that has been subdivided into a plurality of first NIC bandwidth subsets that are each dedicated to a respective one of the first GPU and the second GPU, and wherein the second NIC includes a second NIC bandwidth that has been subdivided into a plurality of second NIC bandwidth subsets that are each dedicated to a respective one of the first GPU and the second GPU.

8. An Information Handling System (IHS), comprising:
a chassis;
a Network Interface Controller (NIC) set that is included in the chassis and that provides access to each of a plurality of external fabrics;
a plurality of Graphics Processing Units (GPUs) that are included in the chassis; and
an internal switch fabric that is included in the chassis and configured to couple each of the plurality of GPUs to the NIC set to provide each of the plurality of GPUs access to each of the plurality of external fabrics.

9. The IHS of claim 8, wherein the NIC set includes a first NIC that provides access to a first external fabric included in the plurality of external fabrics, and a second NIC that provides access to a second external fabric included in the plurality of external fabrics, and wherein the internal switch fabric is configured to:
couple a first GPU included in the plurality of GPUs to each of the first NIC and the second NIC to provide the first GPU access to each of the first external fabric and the second external fabric; and
couple a second GPU included in the plurality of GPUs to each of the first NIC and the second NIC to provide the second GPU access to each of the first external fabric and the second external fabric.

10. The IHS of claim 8, wherein the NIC set includes a first NIC that provides access to a both a first external fabric and a second external fabric included in the plurality of external fabrics, and wherein the internal switch fabric is configured to:
couple a first GPU included in the plurality of GPUs to the first NIC to provide the first GPU access to each of the first external fabric and the second external fabric.

11. The IHS of claim 8, wherein the NIC set includes a first NIC and a second NIC that each provide access to both a first external fabric and a second external fabric included in the plurality of external fabrics, and wherein the internal switch fabric is configured to:
couple a first GPU included in the plurality of GPUs to the first NIC to provide the first GPU access to each of the first external fabric and the second external fabric; and
couple a second GPU included in the plurality of GPUs to the second NIC to provide the second GPU access to each of the first external fabric and the second external fabric.

12. The IHS of claim 8, wherein the NIC set includes a first NIC that provides access to both a first external fabric and a second external fabric included in the plurality of external fabrics, and a second NIC that provides access to both a third external fabric and a fourth external fabric included in the plurality of external fabrics, and wherein the internal switch fabric is configured to:
couple a first GPU included in the plurality of GPUs to each of the first NIC and the second NIC to provide the first GPU access to each of the first external fabric, the second external fabric, the third external fabric, and the fourth external fabric; and
couple a second GPU included in the plurality of GPUs to each of the first NIC and the second NIC to provide the second GPU access to each of the first external fabric, the second external fabric, the third external fabric, and the fourth external fabric.

13. The IHS of claim 12, wherein the first NIC includes a first NIC bandwidth that has been subdivided into a plurality of first NIC bandwidth subsets that are each shared by the first GPU and the second GPU, and wherein the second NIC includes a second NIC bandwidth that has been subdivided into a plurality of second NIC bandwidth subsets that are each shared by the first GPU and the second GPU.

14. The IHS of claim 12, wherein the first NIC includes a first NIC bandwidth that has been subdivided into a plurality of first NIC bandwidth subsets that are each dedicated to a respective one of the first GPU and the second GPU, and wherein the second NIC includes a second NIC bandwidth that has been subdivided into a plurality of second NIC bandwidth subsets that are each dedicated to a respective one of the first GPU and the second GPU.

15. A method for configuring an internal Graphics Processing Unit (GPU)/Network Interface Controller (NIC) parallel switch fabric for an Ethernet Artificial Intelligence (AI) fabric, comprising:
coupling, by a Network Interface Controller (NIC) set that is included in a computing device that also includes a plurality of Graphics Processing Units (GPUs), to a plurality of external fabrics;
coupling, by an internal switch fabric that is included in the computing device, each of the plurality of GPUs to the NIC set to provide each of the plurality of GPUs access to each of the plurality of external fabrics; and
communicating, by at least one of the plurality of GPUs using the plurality of external fabrics, with at least one other GPU.

16. The method of claim 14, wherein the NIC set includes a first NIC that provides access to a first external fabric included in the plurality of external fabrics, and a second NIC that provides access to a second external fabric included in the plurality of external fabrics, and wherein the method further comprises:
coupling, by the internal switch fabric, a first GPU included in the plurality of GPUs to each of the first NIC and the second NIC to provide the first GPU access to each of the first external fabric and the second external fabric; and
coupling, by the internal switch fabric, a second GPU included in the plurality of GPUs to each of the first NIC and the second NIC to provide the second GPU access to each of the first external fabric and the second external fabric.

17. The method of claim 14, wherein the NIC set includes a first NIC that provides access to a both a first external fabric and a second external fabric included in the plurality of external fabrics, and wherein the method further comprises:
coupling, by the internal switch fabric, a first GPU included in the plurality of GPUs to the first NIC to provide the first GPU access to each of the first external fabric and the second external fabric.

18. The method of claim 14, wherein the NIC set includes a first NIC and a second NIC that each provide access to both a first external fabric and a second external fabric included in the plurality of external fabrics, and wherein the method further comprises:
coupling, by the internal switch fabric, a first GPU included in the plurality of GPUs to the first NIC to provide the first GPU access to each of the first external fabric and the second external fabric; and
coupling, by the internal switch fabric, a second GPU included in the plurality of GPUs to the second NIC to provide the second GPU access to each of the first external fabric and the second external fabric.

19. The method of claim 14, wherein the NIC set includes a first NIC that provides access to both a first external fabric and a second external fabric included in the plurality of external fabrics, and a second NIC that provides access to both a third external fabric and a fourth external fabric included in the plurality of external fabrics, and wherein the method further comprises:
coupling, by the internal switch fabric, a first GPU included in the plurality of GPUs to each of the first NIC and the second NIC to provide the first GPU access to each of the first external fabric, the second external fabric, the third external fabric, and the fourth external fabric; and
coupling, by the internal switch fabric, a second GPU included in the plurality of GPUs to each of the first NIC and the second NIC to provide the second GPU access to each of the first external fabric, the second external fabric, the third external fabric, and the fourth external fabric.

20. The method of claim 19, further comprising:
subdividing, by the first NIC, a first NIC bandwidth of the first NIC into a plurality of first NIC bandwidth subsets that are each dedicated to a respective one of the first GPU and the second GPU; and
subdividing, by the second NIC, a second NIC bandwidth of the second NIC into a plurality of second NIC bandwidth subsets that are each dedicated to a respective one of the first GPU and the second GPU.
